(19) United States
(12) Patent Application Publication
(10) Pub. No.: US 2024/0375049 A1
(43) Pub. Date: Nov. 14, 2024

(54) NOX ADSORBER DOC (NA-DOC) CATALYST

(71) Applicant: BASF CORPORATION, Florham Park, NJ (US)

(72) Inventors: Arne Tobias NIGGEBAUM, Hannover (DE); Gerd GRUBERT, Hannover (DE); Sven Jare LOHMEIER, Hannover (DE); Emre EMMEZ, Ludwigshafen am Rhein (DE); Torsten NEUBAUER, Hannover (DE)

(21) Appl. No.: 18/690,430

(22) PCT Filed: Sep. 13, 2022
(86) PCT No.: PCT/EP2022/075372

§ 371 Date: Mar. 8, 2024

(30) Foreign Application Priority Data
Sep. 14, 2021 (EP) 21196664.3

(51) Int. Cl. B01D 53/94; B01J 23/56; B01J 35/00

(52) U.S. Cl. CPC B01D 53/9477; B01J 23/56; B01J 35/19; B01D 2253/1122; B01D 2253/1124; B01D 2255/1023; B01D 2255/2042; B01D 2255/2065; B01D 2255/2092; B01D 2255/30; B01D 2255/9025; B01D 2255/91; B01D 2258/012

(57) ABSTRACT

A NOx adsorber diesel oxidation catalyst for the treatment of an exhaust gas, the catalyst comprising: a substrate comprising an inlet end, an outlet end, a substrate axial length extending from the inlet end to the outlet end and a plurality of passages defined by internal walls of the substrate extending therethrough; a first NOx adsorber (NA) coating, said coating comprising palladium supported on a first non-zeolitic oxidic material comprising ceria; a second NOx adsorber (NA) coating, said coating comprising one or more of an alkaline earth metal supported on a support material and a platinum group metal component supported on a second non-zeolitic oxidic material; and a diesel oxidation catalyst (DOC) coating, said coating comprising a platinum group metal component supported on a third non-zeolitic oxidic material.

The present invention relates to a NOx adsorber diesel oxidation catalyst, a process for preparing said catalyst and a use of said catalyst. Further, the present invention relates to an exhaust gas treatment system comprising said catalyst.

In the automotive industry, there is a continuous need to reduce NOx emissions from engines as these emissions are harmful for humans. Thus, it is important to cope with present legislations setting limits for NOx emissions. NOx adsorber diesel oxidation catalysts are thus used together with selective catalytic reduction catalysts.

Lean NOx traps (LNTs) adsorb NOx during cold start of an engine to minimize emissions before the downstream selective catalytic reduction (SCR) catalyst has reached light-off temperature. Regeneration of LNT is generally done by temporarily switching to rich exhaust gas conditions and adsorbed NOx is reduced to N₂ over the LNT. According to the state of the art, ceria- or barium-based material are used and adsorption occurs via NO₂. Typically, NOx adsorption capacity and NOx desorption temperatures are high for LNTs.

WO 2016/141142 A1 discloses a lean NOx trap comprising barium and ceria. WO 2020/236879 A1 discloses an emission treatment system for oxidation of hydrocarbons and carbon monoxide and for NOx abatement in an exhaust gas of a lean burn engine, the system comprising a low-temperature NOx adsorber that comprises a molecular sieve impregnated with a platinum group metal used in combination with a diesel oxidation catalyst comprising a manganese-containing support material. However, there is still a need to provide a new NOx adsorber diesel oxidation catalyst (NA-DOC) for the treatment of an exhaust gas that exhibits in particular an improved performance with respect to its NOx adsorption and/or desorption properties, in particular at low temperatures and shows good thermal lean desulfation behavior and/or a high stability against repeated lean/rich desulfation.

It was therefore an object of the present invention to provide a NOx adsorber diesel oxidation catalyst (NA-DOC) for the treatment of an exhaust gas, wherein the catalyst exhibits in particular an improved performance with respect to its NOx adsorption and/or desorption properties, in particular at low temperatures and also provides lean or lean/rich desulfation capabilities.

Surprisingly, it was found that the NOx adsorber diesel oxidation catalyst according to the present invention permits to maintain high and durable NOx adsorption/desorption even at low temperatures and permits to prevent irreversible damages from sulfation/desulfation.

Therefore, the present invention relates to a NOx adsorber diesel oxidation catalyst (NA-DOC) for the treatment of an exhaust gas, the catalyst comprising:
(i) a substrate comprising an inlet end, an outlet end, a substrate axial length extending from the inlet end to the outlet end and a plurality of passages defined by internal walls of the substrate extending therethrough;
(ii) a first NOx adsorber (NA) coating, said coating comprising palladium supported on a first non-zeolitic oxidic material comprising ceria;
(iii) a second NOx adsorber (NA) coating, said coating comprising one or more of an alkaline earth metal supported on a support material and a platinum group metal component supported on a second non-zeolitic oxidic material;
(iv) a diesel oxidation catalyst (DOC) coating, said coating comprising a platinum group metal component supported on a third non-zeolitic oxidic material;
wherein the first NA coating (ii) is disposed on the surface of the internal walls of the substrate (i) over x % of the substrate axial length from the outlet end toward the inlet end of said substrate, with x being in the range of from 20 to 70;
wherein the second NA coating (iii) is disposed over y % of the substrate axial length from the inlet end toward the outlet end of said substrate, with y being in the range of from 20 to 70;
wherein the DOC coating is disposed on the first NA coating and the second NA coating, or on the first NA coating, the second NA coating and the surface of the internal walls of the substrate, over z % of the substrate axial length, with z being in the range of from 50 to 100.

Preferably x is in the range of from 30 to 65, more preferably in the range of from 35 to 60, more preferably in the range of from 40 to 55, more preferably in the range of from 45 to 55.

Preferably y is in the range of from 30 to 65, more preferably in the range of from 35 to 60, more preferably in the range of from 40 to 55, more preferably in the range of from 45 to 55. More preferably x is in the range of from 45 to 55 and y is in the range of from 45 to 55.

Preferably y is 100−x, wherein more preferably x is in the range of from 45 to 55.

Preferably z is in the range of from 70 to 100, more preferably in the range of from 80 to 100, more preferably in the range of from 90 to 100, more preferably in the range of from 95 to 100, more preferably in the range of from 98 to 100, more preferably in the range of from 99 to 100.

Preferably from 95 to 100 weight-%, more preferably from 98 to 100 weight-%, more preferably from 99 to 100 weight-%, more preferably from 99.5 to 100 weight-%, more preferably from 99.9 to 100 weight-%, of the first non-zeolitic oxidic material comprised in the first NA coating (ii) consist of ceria, calculated as CeO₂. In other words, it is preferred that the first non-zeolitic oxidic material comprised in the first NA coating (ii) consists essentially of, more preferably consists of, ceria, calculated as CeO₂.

Preferably the first NA coating comprises palladium at a loading, calculated as elemental Pd, in the range of from 5 to 150 g/ft³, more preferably in the range of from 10 to 120 g/ft³, more preferably in the range of from 30 to 100 g/ft³, more preferably in the range of from 40 to 80 g/ft³, more preferably in the range of from 45 to 75 g/ft³.

Preferably the first NA coating (ii) comprises the first non-zeolitic oxidic material at a loading in the range of from 1 to 6 g/in³, more preferably in the range of from 2 to 5 g/in³, more preferably in the range of from 2.5 to 4.5 g/in³.

Preferably at most 0.01 weight-%, more preferably at most 0.001 weight-%, more preferably at most 0.0001 weight-% of the first NA coating consist of barium, calculated as BaO. In other words, it is preferred that the first NA coating (ii) be essentially free of, more preferably free of, barium, calculated as BaO.

Preferably at most 0.01 weight-%, more preferably at most 0.001 weight-%, more preferably at most 0.0001 weight-% of the first NA coating consist of molecular sieve. In other words, it is preferred that the first NA coating (ii) be essentially free of, more preferably free of, molecular sieve.

Preferably from 95 to 100 weight-%, more preferably from 98 to 100 weight-%, more preferably from 99 to 100 weight-%, more preferably from 99.5 to 100 weight-%, more preferably from 99.9 to 100 weight-%, of the first NA coating (ii) consist of palladium on the first non-zeolitic oxidic material, preferably of palladium on ceria. In other words, it is preferred that the first NA coating (ii) consists essentially of, more preferably consists of, palladium on the first non-zeolitic oxidic material, preferably of palladium on ceria.

In the context of the present invention, it has been found by the inventors that the first NA coating (iii) prevents from irreversible damages from sulfation/desulfation and acts as a lean NOx trap.

In the context of the present invention, it is preferred that the catalyst comprises the second NA coating (iii) at a loading in the range of from 1.5 to 8 g/in³, more preferably in the range of from 2 to 7 g/in³, more preferably in the range of from 3 to 6.5 g/in³, more preferably in the range of from 3.5 to 5.5 g/in³.

Preferably the second NA coating (iii) comprises the platinum group metal component, wherein the platinum group metal component is one or more of Pt, Pd, Rh, Ir, Ru and Os, more preferably one or more of Pt, Pd and Rh, more preferably one or more of Pt and Pd, more preferably Pt and Pd.

Preferably the weight ratio of platinum relative to palladium, calculated as Pt:Pd, is in the range of from 5:1 to 15:1, more preferably in the range of from 7:1 to 12:1, more preferably in the range of from 8:1 to 10:1.

Preferably the second NA coating (iii) comprises the platinum group metal component at a loading, calculated as elemental platinum group metal, in the range of from 5 to 150 g/ft³, more preferably in the range of from 10 to 120 g/ft³, more preferably in the range of from 30 to 100 g/ft³, more preferably in the range of from 40 to 80 g/ft³, more preferably in the range of from 45 to 75 g/ft³.

It is preferred that, in the second NA coating (iii), the second non-zeolitic oxidic material supporting the platinum group metal component be selected from the group consisting of ceria, alumina, zirconia, silica, titania, a mixed oxide comprising one or more of Ce, Al, Zr, Si, and Ti and a mixture of two or more thereof, more preferably selected from the group consisting of ceria, alumina and a mixed oxide comprising one or more of Ce and Al, more preferably selected from the group consisting of ceria and a mixed oxide comprising one or more of Ce and Al, more preferably is a mixed oxide comprising Ce and Al, more preferably a mixed oxide of Ce and Al. Preferably the weight ratio of Ce:Al, calculated as CeO₂:Al₂O₃, more preferably is in the range of from 10:90 to 90:10, more preferably in the range of from 20:80 to 50:50, more preferably in the range of from 25:75 to 50:50.

Preferably, according to an alternative, at most 0.01 weight-%, more preferably at most 0.001 weight-%, more preferably at most 0.0001 weight-% of the second NA coating consist of barium, calculated as BaO. In other words, it is preferred that the second NA coating (iii) is essentially free of, more preferably free of, barium, calculated as BaO. Such alternative is for example illustrated by Example 2.2 herein below.

In the context of the present invention, it is preferred that the second NA coating (iii) further comprises an oxidic component selected from the group consisting of ceria, zirconia, alumina, silica, titania, a mixed oxide comprising one or more of Ce, Zr, Al, Si, and Ti and a mixture of two or more thereof, more preferably selected from the group consisting of ceria, zirconia, alumina and titania, more preferably selected from the group consisting of ceria, zirconia, and alumina, more preferably is ceria.

Preferably from 95 to 100 weight-%, more preferably from 98 to 100 weight-%, more preferably from 99 to 100 weight-%, more preferably from 99.5 to 100 weight-%, more preferably from 99.9 to 100 weight-%, of the oxidic component comprised in the second NA coating (iii) consist of ceria, calculated as CeO₂. In other words, it is preferred that the oxidic component comprised in the second NA coating consists essentially of, more preferably consists of, ceria, calculated as CeO₂.

Preferably the second NA coating (iii) comprises the oxidic component at a loading in the range of from 0.5 to 9 g/in³, more preferably in the range of from 1 to 8 g/in³, more preferably in the range of from 2 to 6 g/in³, more preferably in the range of from 2.75 to 5 g/in³.

In the context of the present invention, according to a further alternative, it is preferred that the second NA coating (iii) comprises the alkaline earth metal supported on a support material and the platinum group metal component supported on a second non-zeolitic oxidic material. This is for example illustrated by Example 4 herein below.

More preferably, in the second NA coating (iii), the weight ratio of the second non-zeolitic oxidic material relative to the support material is in the range of from 0.05:1 to 0.9:1, more preferably in the range of from 0.1:1 to 0.7:1, more preferably in the range of from 0.15:1 to 0.5:1, more preferably in the range of from 0.17:1 to 0.25:1.

Preferably the alkaline earth metal supported on the support material comprised in the second NA coating (iii) is selected from the group consisting of barium, strontium, calcium and magnesium, more preferably selected from the group consisting of barium, strontium and magnesium, more preferably is barium. More preferably the alkaline earth metal comprised in the second NA coating (iii) is present as oxides, cations and/or carbonates.

Preferably the second NA coating (iii) comprises the alkaline earth metal in an amount, calculated as the oxide, in the range of from 0.25 to 10 weight-%, more preferably in the range of from 0.5 to 8 weight-%, more preferably in the range of from 1 to 6 weight-%, more preferably in the range of from 1.25 to 4 weight-%, more preferably in the range of from 1.5 to 3 weight-%, based on the weight of the support material comprised in the second NA coating (iii).

Preferably the support material supporting the alkaline earth metal in the second NA coating (iii), more preferably barium, is selected from the group consisting of ceria, zirconia, alumina, silica, titania, a mixed oxide comprising one or more of Ce, Zr, Al, Si, and Ti and a mixture of two or more thereof, more preferably selected from the group consisting of ceria, zirconia, alumina and titania, more preferably selected from the group consisting of ceria, zirconia, and alumina, more preferably is ceria.

Preferably from 95 to 100 weight-%, more preferably from 98 to 100 weight-%, more preferably from 99 to 100 weight-%, more preferably from 99.5 to 100 weight-%, more preferably from 99.9 to 100 weight-%, of the support material comprised in the second NA coating (iii) consist of ceria, calculated as CeO₂. In other words, it is preferred that the support material comprised in the second NA coating (iii) consists essentially of, more preferably consists of, ceria, calculated as CeO₂. More preferably the support material supporting barium in the second NA coating (iii) is ceria.

Preferably the second NA coating (iii) comprises the support material supporting the alkaline earth metal at a loading in the range of from 0.5 to 9 g/in³, more preferably in the range of from 1 to 8 g/in³, more preferably in the range of from 2 to 6 g/in³, more preferably in the range of from 2.75 to 5 g/in³.

In the context of the present invention, the second NA coating (iii) preferably further comprises an oxidic material comprises one or more of zirconia, alumina, silica, magnesium oxide, strontium oxide, lanthana, praseodymium oxide, neodymium oxide and titania, more preferably one or more of zirconia, alumina, magnesium oxide and titania, more preferably selected from the group consisting of zirconia, alumina and magnesium oxide, more preferably one or more of zirconia and magnesium oxide, more preferably zirconia and magnesium oxide. Preferably the weight ratio of zirconia to magnesium oxide is in the range of from 0.5:1 to 1:0.5, more preferably in the range of from 0.75:1 to 1:0.75, more preferably in the range of from 0.9:1 to 1:0.9.

Preferably the second NA coating (iii) comprises the oxidic material in an amount in the range of from 0.5 to 5 weight-%, more preferably in the range of from 1 to 4 weight-%, more preferably in the range of from 1.5 to 3.5 weight-%, based on the weight of the second NA coating (iii).

Preferably the second NA coating (iii) is disposed on the surface of the internal walls of the substrate (i).

Preferably the second NA coating (iii) acts as a lean NOx trap.

Preferably at most 0.1 weight-%, preferably at most 0.01 weight-%, more preferably at most 0.001 weight-%, more preferably at most 0.0001 weight-%, of the second NA coating (iii) consists of a molecular sieve. In other words, it is preferred that the second NA coating (iii) be essentially free of, more preferably free of, a molecular sieve.

Preferably from 95 to 100 weight-%, more preferably from 98 to 100 weight-%, more preferably from 99 to 100 weight-%, more preferably from 99.5 to 100 weight-%, more preferably from 99.9 to 100 weight-%, of the second NA coating (iii) consist of the platinum group metal component supported on the second non-zeolitic oxidic material, more preferably an oxidic component as defined in the foregoing and more preferably an oxidic material as defined in the foregoing. In other words, it is preferred that the second NA coating (iii) consists essentially of, more preferably consists of, the platinum group metal component supported on the second non-zeolitic oxidic material, more preferably an oxidic component as defined in the foregoing and more preferably an oxidic material as defined in the foregoing

It is alternatively preferred that from 95 to 100 weight-%, more preferably from 98 to 100 weight-%, more preferably from 99 to 100 weight-%, more preferably from 99.5 to 100 weight-%, more preferably from 99.9 to 100 weight-%, of the second NA coating (iii) consist of the alkaline earth metal supported on the support material, the platinum group metal component supported on the second non-zeolitic oxidic material, and preferably an oxidic material as defined in the foregoing. In other words, it is preferred that the second NA coating (iii) consists essentially of, more preferably consists of, the alkaline earth metal supported on the support material, the platinum group metal component supported on the second non-zeolitic oxidic material, and more preferably an oxidic material as defined in the foregoing.

Preferably the platinum group metal component comprised in the DOC coating (iv) is one or more of Pt, Pd, Rh, Ir, Ru and Os, more preferably one or more of Pt, Pd and Rh, more preferably one or more of Pt and Pd, more preferably Pt and Pd. Preferably the weight ratio of platinum relative to palladium, calculated as Pt:Pd, is in the range of from 2:1 to 20:1, more preferably in the range of from 5:1 to 15:1, more preferably in the range of from 7:1 to 12:1, more preferably in the range of from 8:1 to 10:1.

Preferably the DOC coating (iv) further comprises the platinum group metal component at a loading, calculated as elemental platinum group metal, in the range of from 5 to 150 g/ft³, more preferably in the range of from 10 to 120 g/ft³, more preferably in the range of from 30 to 100 g/ft³, more preferably in the range of from 40 to 80 g/ft³, more preferably in the range of from 45 to 75 g/ft³.

Preferably the third non-zeolitic oxidic material comprised in the DOC coating (iv) is selected from the group consisting of alumina, zirconia, silica, titania, a mixed oxide comprising one or more of Al, Zr, Si, and Ti and a mixture of two or more thereof, more preferably selected from the group consisting of silica, alumina and a mixed oxide comprising one or more of Si and Al, more preferably selected from the group consisting of alumina and a mixed oxide comprising one or more of Si and Al, more preferably is a mixed oxide comprising Si and Al, more preferably a mixed oxide of Si and Al. Preferably from 90 to 99 weight-%, more preferably from 92 to 98 weight-%, more preferably from 93 to 97 weight-%, of the second non-zeolitic material comprised in the DOC coating (iv) consist of alumina, and preferably from 1 to 10 weight-%, more preferably from 2 to 8 weight-%, more preferably from 3 to 7 weight-%, of the DOC coating (iv) consist of silica.

Preferably the DOC coating (iv) comprises the third non-zeolitic oxidic material at a loading in the range of from 0.5 to 3 g/in³, preferably in the range of from 0.75 to 2.5 g/in³, more preferably in the range of from 0.9 to 2 g/in³.

Preferably the DOC coating (iv) further comprises a zeolitic material comprising one or more of iron and copper, more preferably a zeolitic material comprising iron. Preferably the DOC coating (iii) comprises iron in an amount, calculated as Fe₂O₃, in the range of from 0.25 to 4 weight-%, more preferably in the range of from 0.5 to 3 weight-%, more preferably in the range of from 0.75 to 2.5 weight-%, based on the weight of the zeolitic material comprising iron comprised in the DOC coating (iv). Alternatively, it is preferred that the DOC coating (iv) further comprises a zeolitic material it is H- and/or NH₄-form.

Preferably the zeolitic material comprised in the DOC coating (iv) is a 12-membered ring pore zeolitic material, said zeolitic material more preferably having a framework type selected from the group consisting of BEA, MOR, FAU, GME, OFF a mixture of two or more thereof and a mixed type of two or more thereof, more preferably selected from the group consisting of BEA, MOR, FAU, a mixture of two or more thereof and a mixed type of two or more thereof, more preferably selected from the group consisting of BEA and FAU. It is more preferred that the 12-membered ring pore zeolitic material comprised in the DOC coating (iv) has a framework type BEA.

Preferably from 95 to 100 weight-%, more preferably from 98 to 100 weight-%, more preferably from 99 to 100 weight-%, more preferably from 99.5 to 100 weight-%, of the framework structure of the 12-membered ring pore zeolitic material comprised in the DOC coating (iv) consist of Si, Al, and O.

It is preferred that in the framework structure of the 12-membered ring pore zeolitic material comprised in the DOC coating (iv), the molar ratio of Si to Al, calculated as molar SiO₂:Al₂O₃, is in the range of from 2:1 to 60:1, more preferably in the range of from 2:1 to 50:1, more preferably in the range of from 5:1 to 40:1, more preferably in the range of from 10:1 to 35:1, more preferably in the range of from 15:1 to 30:1, more preferably in the range of from 20:1 to 30:1, more preferably in the range of from 23:1 to 29:1.

Preferably the DOC coating (iv) comprises the zeolitic material in an amount in the range of from 15 to 50 weight-%, more preferably in the range of from 20 to 45 weight-%, more preferably in the range of from 25 to 43 weight-%, based on the weight of the third non-zeolitic oxidic material comprised in the DOC coating (iv).

Preferably the DOC coating (iv) further comprises an oxidic material comprising an alkaline earth metal, wherein the alkaline earth metal more preferably is one or more of Ba, Mg, Ca and Sr, more preferably one or more of Ba, Mg and Ca, more preferably one or more of Ba and Mg, more preferably Ba. It is more preferred that the oxidic material comprising an alkaline earth metal be BaO.

Preferably the DOC coating (iv) comprises the oxidic material in an amount in the range of from 1 to 15 weight-%, more preferably in the range of from 3 to 10 weight-%, more preferably in the range of from 5 to 9 weight-%, based on the weight of the third non-zeolitic oxidic material comprised in the DOC coating (iv).

Preferably the catalyst comprises the DOC coating (iv) at a loading in the range of from 0.75 to 3.5 g/in³, more preferably in the range of from 0.9 to 3 g/in³, more preferably in the range of from 1 to 2.5 g/in³.

Preferably at most 0.1 weight-%, more preferably at most 0.01 weight-%, more preferably at most 0.001 weight-%, more preferably at most 0.0001 weight-%, of the second NA coating (iii) consists of ceria. In other words, it is preferred that the second NA coating (iii) is essentially free of, more preferably free of, ceria.

Preferably from 95 to 100 weight-%, more preferably from 98 to 100 weight-%, more preferably from 99 to 100 weight-%, more preferably from 99.5 to 100 weight-%, more preferably from 99.9 to 100 weight-%, of the DOC coating (iv) consist of the platinum group metal component supported on the third non-zeolitic oxidic material, more preferably a zeolitic material comprising one or more of Fe and Cu as defined in the foregoing, and more preferably an oxidic material comprising an alkaline earth metal as defined in the foregoing. In other words, it is preferred that the DOC coating (iv) consists essentially of, more preferably consists of, the platinum group metal component supported on the third non-zeolitic oxidic material, more preferably a zeolitic material comprising one or more of Fe and Cu as defined in the foregoing, and more preferably an oxidic material comprising an alkaline earth metal as defined in the foregoing.

As to the substrate (i), it is preferred that it is a flow-through substrate or a wall-flow filter substrate, more preferably a flow-through substrate.

Preferably the flow-through substrate (i) comprises, more preferably consists of, a ceramic substance. Preferably the ceramic substance comprises, more preferably consists of, one or more of an alumina, a silica, a silicate, an aluminosilicate, more preferably a cordierite or a mullite, an aluminotitanate, a silicon carbide, a zirconia, a magnesia, preferably a spinel, and a titania, more preferably one or more of a silicon carbide and a cordierite, more preferably a cordierite.

Alternatively, the flow-through substrate (i) preferably comprises, more preferably consists of, a metallic substance. The metallic substance preferably comprises, more preferably consists of, oxygen and one or more of iron, chromium and aluminum.

It is preferred that the catalyst of the present invention and as defined in the foregoing consists of the substrate (i), the first NA coating (ii), the second NA coating (iii) and the DOC coating (iv).

The present invention further relates to a process for preparing a NOx adsorber diesel oxidation catalyst (NA-DOC) according to the present invention, comprising
(a) preparing a first mixture comprising water, a source of palladium and a first non-zeolitic oxidic material comprising ceria;
(b) disposing the first mixture obtained according to (a) on the surface of the internal walls of a substrate comprising an inlet end, an outlet end, a substrate axial length extending from the inlet end to the outlet end and a plurality of passages defined by internal walls of the substrate extending therethrough, over x % of the substrate axial length from the outlet end toward the inlet end of said substrate, with x being in the range of from 20 to 70; calcining, obtaining a substrate having a first NOx adsorber (NA) coating thereon;
(c) preparing a second mixture comprising water and one or more of an alkaline earth metal with a support material for the alkaline earth metal and a source of a platinum group metal component with a second non-zeolitic oxidic material for supporting the platinum group metal component;
(d) disposing the second mixture obtained according to (c) on the substrate, having the first NA coating thereon, over y % of the substrate axial length from the inlet end toward the outlet end of said substrate, with y being in the range of from 20 to 70; calcining, obtaining a substrate having a first NA coating and a second NA coating thereon;
(e) preparing a third mixture comprising water, a source of a platinum group metal component and a third non-zeolitic oxidic material;
(f) disposing the third mixture obtained according to (e) on the substrate, having the first NA coating and the second NA coating thereon, over z % of the substrate axial length, with z being in the range of from 50 to 100;
(g) calcining the substrate obtained according to (f), obtaining a substrate having a first NA coating, a second NA coating and a DOC coating thereon.

Preferably x is in the range of from 30 to 65, more preferably in the range of from 35 to 60, more preferably in the range of from 40 to 55, more preferably in the range of from 45 to 55.

Preferably y is in the range of from 30 to 65, more preferably in the range of from 35 to 60, more preferably in the range of from 40 to 55, more preferably in the range of from 45 to 55. More preferably x is in the range of from 45 to 55 and y is in the range of from 45 to 55.

Preferably y is 100−x, wherein more preferably x is in the range of from 45 to 55.

Preferably z is in the range of from 70 to 100, more preferably in the range of from 80 to 100, more preferably in the range of from 90 to 100, more preferably in the range of from 95 to 100, more preferably in the range of from 98 to 100, more preferably in the range of from 99 to 100.

As to (a), it is preferred that it comprises
(a.1) impregnating a source of palladium, more preferably a palladium salt, more preferably palladium nitrate, onto a first non-zeolitic oxidic material comprising ceria;
(a.2) calcining, more preferably drying prior to calcining, the impregnated material obtained in (a.1), obtaining a powder;
(a.3) admixing water to the powder obtained in (a.2).

As to (b), it is preferred that it further comprises drying prior to calcining, wherein drying is performed in a gas atmosphere having a temperature in the range of from 90 to 160° C., more preferably in the range of from 100 to 120° C. Preferably the gas atmosphere comprises oxygen.

Preferably calcining according to (b) is performed in a gas atmosphere having a temperature in the range of from 300 to 800° C., more preferably in the range of from 400 to 700° C. Preferably the gas atmosphere comprises oxygen.

As to (c), it is preferred that it comprises
(c.1) impregnating a source of a platinum group metal component, more preferably a source of platinum and palladium, onto a second non-zeolitic oxidic material;
(c.2) calcining, more preferably drying prior to calcining, the impregnated material obtained in (c.1), obtaining a powder;
(c.3) admixing water with the powder obtained in (c.2);
(c.4) admixing an oxidic component, more preferably as defined in in the foregoing, to the aqueous mixture obtained in (c.3);
(c.5) preferably adding an oxidic material, preferably as defined in the foregoing, to the aqueous mixture obtained in (c.4).

Alternatively, it is preferred that (c) comprises
(c.1′) impregnating a source of a platinum group metal component, more preferably a source of platinum and palladium, onto a second non-zeolitic oxidic material;
(c.2′) calcining, more preferably drying prior to calcining, the impregnated material obtained in (c.1′), obtaining a powder;
(c.3′) impregnating an alkaline earth metal onto a support material;
(c.4′) calcining, more preferably drying prior to calcining, the impregnated material obtained in (c.3′), obtaining a powder;
(c.5′) admixing water with the powder obtained in (c.2′) and the powder obtained in (c.4′);
(c.6′) more preferably adding an oxidic material, preferably as defined in the foregoing, to the aqueous mixture obtained in (c.5′).

As to (d), it is preferred that it further comprises drying prior to calcining, wherein drying is performed in a gas atmosphere having a temperature in the range of from 90 to 160° C., more preferably in the range of from 100 to 120° C. Preferably the gas atmosphere comprises oxygen.

Preferably calcining according to (d) is performed in a gas atmosphere having a temperature in the range of from 300 to 800° C., more preferably in the range of from 400 to 700° C. Preferably the gas atmosphere comprises oxygen.

As to (e), it is preferred that it comprises
(e.1) impregnating a source of a platinum group metal component, more preferably a source of platinum and palladium, onto a third non-zeolitic oxidic material;
(e.2) impregnating the material obtained in (e.1) with barium hydroxide;
(e.3) admixing water with the impregnated material obtained in (e.2);
(e.4) more preferably admixing a zeolitic material comprising one or more of iron and copper as defined in the foregoing to the aqueous mixture obtained in (e.3).

Preferably (f) further comprises drying the substrate onto which the third mixture has been disposed, wherein drying is performed in a gas atmosphere having a temperature in the range of from 90 to 160° C., more preferably in the range of from 100 to 120° C. Preferably the gas atmosphere comprises oxygen.

Preferably calcining the substrate according to (g) is performed in a gas atmosphere having a temperature in the range of from 300 to 800° C., more preferably in the range of from 400 to 700° C. Preferably the gas atmosphere comprises oxygen.

It is preferred that the process consists of (a), (b), (c), (d), (e), (f) and (g).

The present invention further relates to a NOx adsorber diesel oxidation catalyst (NA-DOC) obtained or obtainable by a process according to the present invention and as defined in the foregoing.

The present invention further relates to a use of a NOx adsorber diesel oxidation catalyst (NA-DOC) according to the present invention and as defined in the foregoing for the NOx adsorption/desorption and the conversion of HC and CO.

The present invention further relates to an exhaust treatment system for the treatment of an exhaust gas, the system comprising
a NOx adsorber diesel oxidation (NA-DOC) catalyst according to the present invention and as defined in the foregoing;
the system preferably further comprises one or more of a selective catalytic reduction (SCR) catalyst, a selective catalytic reduction catalyst on a filter (SCROF) and an ammonia oxidation (AMOX) catalyst.

Preferably the NA-DOC catalyst is located upstream of the one or more of a selective catalytic reduction (SCR) catalyst, a selective catalytic reduction catalyst on a filter (SCROF) and an ammonia oxidation (AMOX) catalyst.

Preferably the system comprises the NOx adsorber diesel oxidation (NA-DOC) catalyst according to the present invention and as defined in the foregoing, a SCR catalyst and an AMOX catalyst,
wherein the NA-DOC catalyst is positioned upstream of the SCR catalyst and the SCR catalyst is positioned upstream of the AMOX catalyst.

Preferably the system further comprises a SCROF catalyst. More preferably the SCROF catalyst is positioned upstream of the SCR catalyst and downstream of the NA-DOC catalyst; or the SCROF catalyst is more preferably positioned downstream of the SCR catalyst and upstream of the AMOX catalyst.

Preferably the system further comprises another SCR catalyst which is positioned upstream of the AMOX catalyst. It is preferred that, when SCROF catalyst is positioned upstream of the SCR catalyst and downstream of the NA-DOC catalyst, the other SCR catalyst is positioned downstream of the SCR catalyst and upstream of the AMOX catalyst. Alternatively, it is preferred that, when the SCROF catalyst is positioned downstream of the SCR catalyst and upstream of the AMOX catalyst, the other SCR catalyst is positioned downstream of the SCROF catalyst and upstream of the AMOX catalyst.

Alternatively, it is preferred that the system comprises the NOx adsorber diesel oxidation (NA-DOC) catalyst according to the present invention and as defined in the foregoing, a SCROF catalyst and an AMOX catalyst, wherein the NA-DOC catalyst is positioned upstream of the SCROF catalyst and the SCROF catalyst is positioned upstream of the AMOX catalyst.

Thus, the system can preferably be as it follows:
NA-DOC cat./SCR cat./AMOX cat.;
NA-DOC cat./SCR cat./SCROF cat./AMOX cat.;
NA-DOC cat./SCR cat./SCROF cat./SCR cat./AMOX cat.;
NA-DOC cat./SCROF cat./AMOX cat.;
NA-DOC cat./SCROF cat./SCR cat./AMOX cat.; or
NA-DOC cat./SCROF cat./SCR cat./SCR cat./AMOX cat.

In the context of the present invention, it is noted that the SCR catalysts, the SCROF catalyst and the AMOX catalyst can be as defined in the art. The skilled person does know which kind of catalysts may be used for these purposes. The NA-DOC catalyst is the catalyst of the present invention and as defined in the foregoing.

The present invention further relates to a method for the treatment of an exhaust gas comprising
providing an exhaust gas, preferably from an internal combustion engine, more preferably from a diesel engine;
contacting the exhaust gas with a NOx adsorber diesel oxidation catalyst according to the present invention and as defined in the foregoing.

The present invention is further illustrated by the following set of embodiments and combinations of embodiments resulting from the dependencies and back-references as indicated. In particular, it is noted in the context of the present invention, that in each instance where a range of embodiments is mentioned, for example in the context of a term such as “The catalyst of any one of embodiments 1 to 5”, every embodiment in this range is meant to be explicitly disclosed for the skilled person, i.e. the wording of this term is to be understood by the skilled person as being synonymous to “The catalyst of any one of embodiments 1, 2, 3, 4 and 5”. Further, it is explicitly noted that the following set of embodiments is not the set of claims determining the extent of protection, but represents a suitably structured part of the description directed to general and preferred aspects of the present invention. It is noted that this is applicable as well for the second set of embodiments.
1. A NOx adsorber diesel oxidation catalyst (NA-DOC) for the treatment of an exhaust gas, the catalyst comprising:
   (i) a substrate comprising an inlet end, an outlet end, a substrate axial length extending from the inlet end to the outlet end and a plurality of passages defined by internal walls of the substrate extending therethrough;
   (ii) a first NOx adsorber (NA) coating, said coating comprising palladium supported on a first non-zeolitic oxidic material comprising ceria;
   (iii) a second NOx adsorber (NA) coating, said coating comprising one or more of an alkaline earth metal supported on a support material and a platinum group metal component supported on a second non-zeolitic oxidic material;
   (iv) a diesel oxidation catalyst (DOC) coating, said coating comprising a platinum group metal component supported on a third non-zeolitic oxidic material;
   wherein the first NA coating (ii) is disposed on the surface of the internal walls of the substrate (i) over x % of the substrate axial length from the outlet end toward the inlet end of said substrate, with x being in the range of from 20 to 70;
   wherein the second NA coating (iii) is disposed over y % of the substrate axial length from the inlet end toward the outlet end of said substrate, with y being in the range of from 20 to 70;
   wherein the DOC coating is disposed on the first NA coating and the second NA coating, or on the first NA coating, the second NA coating and the surface of the internal walls of the substrate, over z % of the substrate axial length, with z being in the range of from 50 to 100.
2. The catalyst of embodiment 1, wherein x is in the range of from 30 to 65, preferably in the range of from 35 to 60, more preferably in the range of from 40 to 55, more preferably in the range of from 45 to 55.
3. The catalyst of embodiment 1 or 2, wherein y is in the range of from 30 to 65, preferably in the range of from 35 to 60, more preferably in the range of from 40 to 55, more preferably in the range of from 45 to 55.
4. The catalyst of any one of embodiments 1 to 3, wherein y is 100−x, wherein preferably x is in the range of from 45 to 55.
5. The catalyst of any one of embodiments 1 to 4, wherein z is in the range of from 70 to 100, preferably in the range of from 80 to 100, more preferably in the range of from 90 to 100, more preferably in the range of from 95 to 100, more preferably in the range of from 98 to 100, more preferably in the range of from 99 to 100.
6. The catalyst of any one of embodiments 1 to 5, wherein from 95 to 100 weight-%, preferably from 98 to 100 weight-%, more preferably from 99 to 100 weight-%, more preferably from 99.5 to 100 weight-%, more preferably from 99.9 to 100 weight-%, of the first non-zeolitic oxidic material comprised in the first NA coating (ii) consist of ceria, calculated as CeO₂.
7. The catalyst of any one of embodiments 1 to 6, wherein the first NA coating (ii) comprises palladium at a loading, calculated as elemental Pd, in the range of from 5 to 150 g/ft³, preferably in the range of from 10 to 120 g/ft³, more preferably in the range of from 30 to 100 g/ft³, more preferably in the range of from 40 to 80 g/ft³, more preferably in the range of from 45 to 75 g/ft³.
8. The catalyst of any one of embodiments 1 to 7, wherein the first NA coating comprises the first non-zeolitic oxidic material at a loading in the range of from 1 to 6 g/in³, preferably in the range of from 2 to 5 g/in³, more preferably in the range of from 2.5 to 4.5 g/in³.
9. The catalyst of any one of embodiments 1 to 8, wherein at most 0.01 weight-%, preferably at most 0.001 weight-%, more preferably at most 0.0001 weight-% of the first NA coating consist of barium, calculated as BaO.
10. The catalyst of any one of embodiments 1 to 9, wherein at most 0.01 weight-%, preferably at most 0.001 weight-%, more preferably at most 0.0001 weight-% of the first NA coating consist of molecular sieve.
11. The catalyst of any one of embodiments 1 to 10, wherein from 95 to 100 weight-%, preferably from 98 to 100 weight-%, more preferably from 99 to 100 weight-%, more preferably from 99.5 to 100 weight-%, more preferably from 99.9 to 100 weight-%, of the first NA coating (ii) consist of palladium on the first non-zeolitic oxidic material, preferably of palladium on ceria.
12. The catalyst of any one of embodiments 1 to 11, wherein the first NA coating (iii) prevents from irreversible damages from sulfation/desulfation and acts as a lean NOx trap.
13. The catalyst of any one of embodiments 1 to 12, comprising the second NA coating at a loading in the range of from 1.5 to 8 g/in³, preferably in the range of from 2 to 7 g/in³, more preferably in the range of from 3 to 6.5 g/in³, more preferably in the range of from 3.5 to 5.5 g/in³.
14. The catalyst of any one of embodiments 1 to 13, wherein the second NA coating (iii) comprises the platinum group metal component, wherein the platinum group metal component is one or more of Pt, Pd, Rh, Ir, Ru and Os, preferably one or more of Pt, Pd and Rh, more preferably one or more of Pt and Pd, more preferably Pt and Pd;
   wherein the weight ratio of platinum relative to palladium, calculated as Pt:Pd, is preferably in the range of from 5:1 to 15:1, more preferably in the range of from 7:1 to 12:1, more preferably in the range of from 8:1 to 10:1.
15. The catalyst of any one of embodiments 1 to 14, wherein the second NA coating (iii) comprises the platinum group metal component at a loading, calculated as elemental platinum group metal, in the range of from 5 to 150 g/ft³, preferably in the range of from 10 to 120 g/ft³, more preferably in the range of from 30 to 100 g/ft³, more preferably in the range of from 40 to 80 g/ft³, more preferably in the range of from 45 to 75 g/ft³.
16. The catalyst of any one of embodiments 1 to 15, wherein, in the second NA coating (iii), the second non-zeolitic oxidic material supporting the platinum group metal component is selected from the group consisting of ceria, alumina, zirconia, silica, titania, a mixed oxide comprising one or more of Ce, Al, Zr, Si, and Ti and a mixture of two or more thereof, preferably selected from the group consisting of ceria, alumina and a mixed oxide comprising one or more of Ce and Al, more preferably selected from the group consisting of ceria and a mixed oxide comprising one or more of Ce and Al, more preferably is a mixed oxide comprising Ce and Al, more preferably a mixed oxide of Ce and Al;
   wherein the weight ratio of Ce:Al, calculated as CeO₂:Al₂O₃, more preferably is in the range of from 10:90 to 90:10, more preferably in the range of from 20:80 to 50:50, more preferably in the range of from 25:75 to 50:50.
17. The catalyst of any one of embodiments 1 to 16, wherein at most 0.01 weight-%, preferably at most 0.001 weight-%, more preferably at most 0.0001 weight-% of the second NA coating consist of barium, calculated as BaO.
18. The catalyst of any one of embodiments 1 to 17, wherein the second NA coating (iii) further comprises an oxidic component selected from the group consisting of ceria, zirconia, alumina, silica, titania, a mixed oxide comprising one or more of Ce, Zr, Al, Si, and Ti and a mixture of two or more thereof, more preferably selected from the group consisting of ceria, zirconia, alumina and titania, more preferably selected from the group consisting of ceria, zirconia, and alumina, more preferably is ceria.
19. The catalyst of embodiment 18, wherein from 95 to 100 weight-%, preferably from 98 to 100 weight-%, more preferably from 99 to 100 weight-%, more preferably from 99.5 to 100 weight-%, more preferably from 99.9 to 100 weight-%, of the oxidic component comprised in the second NA coating (iii) consist of ceria, calculated as CeO₂.
20. The catalyst of embodiment 18 or 19, wherein the second NA coating (iii) comprises the oxidic component at a loading in the range of from 0.5 to 9 g/in³, preferably in the range of from 1 to 8 g/in³, more preferably in the range of from 2 to 6 g/in³, more preferably in the range of from 2.75 to 5 g/in³.
21. The catalyst of any one of embodiments 1 to 16, wherein the second NA coating (iii) comprises the alkaline earth metal supported on a support material and the platinum group metal component supported on a second non-zeolitic oxidic material.
22. The catalyst of embodiment 21, wherein, in the second NA coating (iii), the weight ratio of the second non-zeolitic oxidic material relative to the support material is in the range of from 0.05:1 to 0.9:1, preferably in the range of from 0.1:1 to 0.7:1, more preferably in the range of from 0.15:1 to 0.5:1, more preferably in the range of from 0.17:1 to 0.25:1.
23. The catalyst of any one of embodiments 1 to 16, 21 and 22, wherein the alkaline earth metal supported on the support material comprised in the second NA coating (iii) is selected from the group consisting of barium, strontium, calcium and magnesium, preferably selected from the group consisting of barium, strontium and magnesium, more preferably is barium;
   wherein the alkaline earth metal comprised in the second NA coating (iii) preferably is present as oxides, cations and/or carbonates.
24. The catalyst of any one of embodiments 1 to 16 and 21 to 23, wherein the second NA coating (iii) comprises the alkaline earth metal in an amount, calculated as the oxide, in the range of from 0.25 to 10 weight-%, more preferably in the range of from 0.5 to 8 weight-%, more preferably in the range of from 1 to 6 weight-%, more preferably in the range of from 1.25 to 4 weight-%, more preferably in the range of from 1.5 to 3 weight-%, based on the weight of the support material comprised in the second NA coating (iii).
25. The catalyst of any one of embodiments 1 to 16 and 21 to 24, wherein the support material supporting the alkaline earth metal in the second NA coating (iii), preferably barium, is selected from the group consisting of ceria, zirconia, alumina, silica, titania, a mixed oxide comprising one or more of Ce, Zr, Al, Si, and Ti and a mixture of two or more thereof, more preferably selected from the group consisting of ceria, zirconia, alumina and titania, more preferably selected from the group consisting of ceria, zirconia, and alumina, more preferably is ceria.
26. The catalyst of embodiment 25, wherein from 95 to 100 weight-%, preferably from 98 to 100 weight-%, more preferably from 99 to 100 weight-%, more preferably from 99.5 to 100 weight-%, more preferably from 99.9 to 100 weight-%, of the support material comprised in the second NA coating (iii) consist of ceria, calculated as CeO₂.
27. The catalyst of any one of embodiments 1 to 16 and 21 to 26, wherein the second NA coating (iii) comprises the support material supporting the alkaline earth metal at a loading in the range of from 0.5 to 9 g/in³, preferably in the range of from 1 to 8 g/in³, more preferably in the range of from 2 to 6 g/in³, more preferably in the range of from 2.75 to 5 g/in³.
28. The catalyst of any one of embodiments 1 to 27, wherein the second NA coating (iii) further comprises an oxidic material comprises one or more of zirconia, alumina, silica, magnesium oxide, strontium oxide, lanthana, praseodymium oxide, neodymium oxide and titania, more preferably one or more of zirconia, alumina, magnesium oxide and titania, more preferably selected from the group consisting of zirconia, alumina and magnesium oxide, more preferably one or more of zirconia and magnesium oxide, more preferably zirconia and magnesium oxide;
   wherein preferably the weight ratio of zirconia to magnesium oxide is in the range of from 0.5:1 to 1:0.5, more preferably in the range of from 0.75:1 to 1:0.75, more preferably in the range of from 0.9:1 to 1:0.9.
29. The catalyst of embodiment 28, wherein the second NA coating (iii) comprises the oxidic material in an amount in the range of from 0.5 to 5 weight-%, preferably in the range of from 1 to 4 weight-%, more preferably in the range of from 1.5 to 3.5 weight-%, based on the weight of the second NA coating (iii).
30. The catalyst on any one of embodiments 1 to 29, wherein the second NA coating (iii) is disposed on the surface of the internal walls of the substrate (i).
31. The catalyst of any one of embodiments 1 to 30, wherein the second NA coating (iii) acts as a lean NOx trap.
32. The catalyst of any one embodiments 1 to 31, wherein at most 0.1 weight-%, preferably at most 0.01 weight-%, more preferably at most 0.001 weight-%, more preferably at most 0.0001 weight-%, of the second NA coating (iii) consists of a molecular sieve.
33. The catalyst of any one embodiments 1 to 20 and 28 to 32, wherein from 95 to 100 weight-%, preferably from 98 to 100 weight-%, more preferably from 99 to 100 weight-%, more preferably from 99.5 to 100 weight-%, more preferably from 99.9 to 100 weight-%, of the second NA coating (iii) consist of the platinum group metal component supported on the second non-zeolitic oxidic material, preferably an oxidic component as defined in any one of embodiments 18 to 20 and more preferably an oxidic material as defined in embodiment 28 or 29.
34. The catalyst of any one embodiments 1 to 16 and 21 to 32, wherein from 95 to 100 weight-%, preferably from 98 to 100 weight-%, more preferably from 99 to 100 weight-%, more preferably from 99.5 to 100 weight-%, more preferably from 99.9 to 100 weight-%, of the second NA coating (iii) consist of the alkaline earth metal supported on the support material, the platinum group metal component supported on the second non-zeolitic oxidic material, and preferably an oxidic material as defined in embodiment 28 or 29.
35. The catalyst of any one of embodiments 1 to 34, wherein the platinum group metal component comprised in the DOC coating (iv) is one or more of Pt, Pd, Rh, Ir, Ru and Os, preferably one or more of Pt, Pd and Rh, more preferably one or more of Pt and Pd, more preferably Pt and Pd;
   wherein the weight ratio of platinum relative to palladium, calculated as Pt:Pd, is preferably in the range of from 2:1 to 20:1, more preferably in the range of from 5:1 to 15:1, more preferably in the range of from 7:1 to 12:1, more preferably in the range of from 8:1 to 10:1.
36. The catalyst of embodiment 35, wherein the DOC coating (iv) further comprises the platinum group metal component at a loading, calculated as elemental platinum group metal, in the range of from 5 to 150 g/ft³, preferably in the range of from 10 to 120 g/ft³, more preferably in the range of from 30 to 100 g/ft³, more preferably in the range of from 40 to 80 g/ft³, more preferably in the range of from 45 to 75 g/ft³.
37. The catalyst of any one of embodiments 1 to 36, wherein the third non-zeolitic oxidic material comprised in the DOC coating (iv) is selected from the group consisting of alumina, zirconia, silica, titania, a mixed oxide comprising one or more of Al, Zr, Si, and Ti and a mixture of two or more thereof, preferably selected from the group consisting of silica, alumina and a mixed oxide comprising one or more of Si and Al, more preferably selected from the group consisting of alumina and a mixed oxide comprising one or more of Si and Al, more preferably is a mixed oxide comprising Si and Al, more preferably a mixed oxide of Si and Al;
   wherein preferably from 90 to 99 weight-%, more preferably from 92 to 98 weight-%, more preferably from 93 to 97 weight-%, of the second non-zeolitic material comprised in the DOC coating (iv) consist of alumina, and wherein preferably from 1 to 10 weight-%, more preferably from 2 to 8 weight-%, more preferably from 3 to 7 weight-%, of the DOC coating (iv) consist of silica.
38. The catalyst of any one of embodiments 1 to 37, wherein the DOC coating (iv) comprises the third non-zeolitic oxidic material at a loading in the range of from 0.5 to 3 g/in³, preferably in the range of from 0.75 to 2.5 g/in³, more preferably in the range of from 0.9 to 2 g/in³.
39. The catalyst of any one of embodiments 1 to 38, wherein the DOC coating (iv) further comprises a zeolitic material comprising one or more of iron and copper, preferably a zeolitic material comprising iron;
   wherein the DOC coating (iii) comprises iron in an amount, calculated as Fe₂O₃, in the range of from 0.25 to 4 weight-%, more preferably in the range of from 0.5 to 3 weight-%, more preferably in the range of from 0.75 to 2.5 weight-%, based on the weight of the zeolitic material comprising iron comprised in the DOC coating (iv); or
   wherein the DOC coating (iv) further comprises a zeolitic material it is H- and/or NH₄-form.
40. The catalyst of embodiment 39, wherein the zeolitic material comprised in the DOC coating (iv) is a 12-membered ring pore zeolitic material, wherein said zeolitic material preferably has a framework type selected from the group consisting of BEA, MOR, FAU, GME, OFF a mixture of two or more thereof and a mixed type of two or more thereof, more preferably selected from the group consisting of BEA, MOR, FAU, a mixture of two or more thereof and a mixed type of two or more thereof, more preferably selected from the group consisting of BEA and FAU, wherein more preferably the 12-membered ring pore zeolitic material comprised in the DOC coating (iv) has a framework type BEA.
41. The catalyst of embodiment 40, wherein from 95 to 100 weight-%, preferably from 98 to 100 weight-%, more preferably from 99 to 100 weight-%, more preferably from 99.5 to 100 weight-%, of the framework structure of the 12-membered ring pore zeolitic material comprised in the DOC coating (iv) consist of Si, Al, and O, wherein in the framework structure, the molar ratio of Si to Al, calculated as molar SiO₂:Al₂O₃, is more preferably in the range of from 2:1 to 60:1, more preferably in the range of from 2:1 to 50:1, more preferably in the range of from 5:1 to 40:1, more preferably in the range of from 10:1 to 35:1, more preferably in the range of from 15:1 to 30:1, more preferably in the range of from 20:1 to 30:1, more preferably in the range of from 23:1 to 29:1.
42. The catalyst of any one embodiments 39 to 41, wherein the DOC coating (iv) comprises the zeolitic material in an amount in the range of from 15 to 50 weight-%, preferably in the range of from 20 to 45 weight-%, more preferably in the range of from 25 to 43 weight-%, based on the weight of the third non-zeolitic oxidic material comprised in the DOC coating (iv).
43. The catalyst of any one of embodiments 1 to 42, wherein the DOC coating (iv) further comprises an oxidic material comprising an alkaline earth metal, wherein the alkaline earth metal preferably is one or more of Ba, Mg, Ca and Sr, more preferably one or more of Ba, Mg and Ca, more preferably one or more of Ba and Mg, more preferably Ba;
   wherein the oxidic material comprising an alkaline earth metal more preferably is BaO;
   wherein the DOC coating (iv) preferably comprises the oxidic material in an amount in the range of from 1 to 15 weight-%, more preferably in the range of from 3 to 10 weight-%, more preferably in the range of from 5 to 9 weight-%, based on the weight of the third non-zeolitic oxidic material comprised in the DOC coating (iv).
44. The catalyst of any one of embodiments 1 to 43, comprising the DOC coating (iv) at a loading in the range of from 0.75 to 3.5 g/in³, preferably in the range of from 0.9 to 3 g/in³, more preferably in the range of from 1 to 2.5 g/in³.
45. The catalyst of any one embodiments 1 to 44, wherein at most 0.1 weight-%, preferably at most 0.01 weight-%, more preferably at most 0.001 weight-%, more preferably at most 0.0001 weight-%, of the second NA coating (iii) consists of ceria.
46. The catalyst of any one embodiments 1 to 45, wherein from 95 to 100 weight-%, preferably from 98 to 100 weight-%, more preferably from 99 to 100 weight-%, more preferably from 99.5 to 100 weight-%, more preferably from 99.9 to 100 weight-%, of the DOC coating (iv) consist of the platinum group metal component supported on the third non-zeolitic oxidic material, preferably a zeolitic material comprising one or more of Fe and Cu as defined in any one of embodiments 39 to 42, and more preferably an oxidic material comprising an alkaline earth metal as defined in embodiment 43.
47. The catalyst of any one of embodiments 1 to 46, wherein the substrate (i) is a flow-through substrate or a wall-flow filter substrate, preferably a flow-through substrate.
48. The catalyst of embodiment 47, wherein the flow-through substrate (i) comprises, preferably consists of, a ceramic substance, wherein the ceramic substance preferably comprises, more preferably consists of, one or more of an alumina, a silica, a silicate, an aluminosilicate, preferably a cordierite or a mullite, an aluminotitanate, a silicon carbide, a zirconia, a magnesia, preferably a spinel, and a titania, more preferably one or more of a silicon carbide and a cordierite, more preferably a cordierite.
49. The catalyst of embodiment 47, wherein the flow-through substrate (i) comprises, preferably consists of, a metallic substance, wherein the metallic substance preferably comprises, more preferably consists of, oxygen and one or more of iron, chromium and aluminum.
50. The catalyst of any one of embodiments 1 to 49, consisting of the substrate (i), the first NA coating (ii), the second NA coating (iii) and the DOC coating (iv).
51. Process for preparing a NOx adsorber diesel oxidation catalyst (NA-DOC) according to any one of embodiments 1 to 50, comprising
   (a) preparing a first mixture comprising water, a source of palladium and a first non-zeolitic oxidic material comprising ceria;
   (b) disposing the first mixture obtained according to (a) on the surface of the internal walls of a substrate comprising an inlet end, an outlet end, a substrate axial length extending from the inlet end to the outlet end and a plurality of passages defined by internal walls of the substrate extending therethrough, over x % of the substrate axial length from the outlet end toward the inlet end of said substrate, with x being in the range of from 20 to 70; calcining, obtaining a substrate having a first NOx adsorber (NA) coating thereon;
   (c) preparing a second mixture comprising water and one or more of an alkaline earth metal with a support material for the alkaline earth metal and a source of a platinum group metal component with a second non-zeolitic oxidic material for supporting the platinum group metal component;
   (d) disposing the second mixture obtained according to (c) on the substrate, having the first NA coating thereon, over y % of the substrate axial length from the inlet end toward the outlet end of said substrate, with y being in the range of from 20 to 70; calcining, obtaining a substrate having a first NA coating and a second NA coating thereon;
   (e) preparing a third mixture comprising water, a source of a platinum group metal component and a third non-zeolitic oxidic material;
   (f) disposing the third mixture obtained according to (e) on the substrate, having the first NA coating and the second NA coating thereon, over z % of the substrate axial length, with z being in the range of from 50 to 100;
   (g) calcining the substrate obtained according to (f), obtaining a substrate having a first NA coating, a second NA coating and a DOC coating thereon.
52. The process of embodiment 50, wherein (a) comprises
   (a.1) impregnating a source of palladium, preferably a palladium salt, more preferably palladium nitrate, onto a first non-zeolitic oxidic material comprising ceria;
(a.2) calcining, preferably drying prior to calcining, the impregnated material obtained in (a.1), obtaining a powder;
(a.3) admixing water to the powder obtained in (a.2).

53. The process of embodiment 51 or 52, wherein (b) further comprises drying prior to calcining, wherein drying is performed in a gas atmosphere having a temperature in the range of from 90 to 160° C., preferably in the range of from 100 to 120° C., the gas atmosphere preferably comprising oxygen.
54. The process of any one of embodiments 51 to 53, wherein calcining according to (b) is performed in a gas atmosphere having a temperature in the range of from 300 to 800° C., preferably in the range of from 400 to 700° C., the gas atmosphere preferably comprising oxygen.
55. The process of any one of embodiments 51 to 54, wherein (c) comprises (c.1) impregnating a source of a platinum group metal component, preferably a source of platinum and palladium, onto a second non-zeolitic oxidic material;
   (c.2) calcining, preferably drying prior to calcining, the impregnated material obtained in (c.1), obtaining a powder;
   (c.3) admixing water with the powder obtained in (c.2);
   (c.4) admixing an oxidic component, preferably as defined in any one of embodiments 18 to 20, to the aqueous mixture obtained in (c.3);
   (c.5) preferably adding an oxidic material, preferably as defined in embodiment 28 or 29, to the aqueous mixture obtained in (c.4).
56. The process of any one of embodiments 51 to 54, wherein (c) comprises
   (c.1′) impregnating a source of a platinum group metal component, preferably a source of platinum and palladium, onto a second non-zeolitic oxidic material;
   (c.2′) calcining, preferably drying prior to calcining, the impregnated material obtained in (c.1′), obtaining a powder;
   (c.3′) impregnating an alkaline earth metal onto a support material;
   (c.4′) calcining, preferably drying prior to calcining, the impregnated material obtained in (c.3′), obtaining a powder;
   (c.5′) admixing water with the powder obtained in (c.2′) and the powder obtained in (c.4′);
   (c.6′) preferably adding an oxidic material, preferably as defined in embodiment 28 or 29, to the aqueous mixture obtained in (c.5′).
57. The process of any one of embodiments 51 to 56, wherein (d) further comprises drying prior to calcining, wherein drying is performed in a gas atmosphere having a temperature in the range of from 90 to 160° C., preferably in the range of from 100 to 120° C., the gas atmosphere preferably comprising oxygen.
58. The process of any one of embodiments 51 to 57, wherein calcining according to (d) is performed in a gas atmosphere having a temperature in the range of from 300 to 800° C., preferably in the range of from 400 to 700° C., the gas atmosphere preferably comprising oxygen.
59. The process of any one of embodiments 51 to 58, wherein (e) comprises
   (e.1) impregnating a source of a platinum group metal component, preferably a source of platinum and palladium, onto a third non-zeolitic oxidic material;
   (e.2) impregnating the material obtained in (e.1) with barium hydroxide;
   (e.3) admixing water with the impregnated material obtained in (e.2);
   (e.4) preferably admixing a zeolitic material comprising one or more of iron and copper as defined in any one of embodiments 39 to 42 to the aqueous mixture obtained in (e.3).
60. The process of any one of embodiments 51 to 59, wherein (f) further comprises drying the substrate onto which the third mixture has been disposed, wherein drying is performed in a gas atmosphere having a temperature in the range of from 90 to 160° C., preferably in the range of from 100 to 120° C., the gas atmosphere preferably comprising oxygen.
61. The process of any one of embodiments 51 to 60, wherein calcining the substrate according to (g) is performed in a gas atmosphere having a temperature in the range of from 300 to 800° C., preferably in the range of from 400 to 700° C., the gas atmosphere preferably comprising oxygen.
62. The process of any one of embodiments 51 to 61, consisting of (a), (b), (c), (d), (e), (f) and (g).
63. A NOx adsorber diesel oxidation catalyst (NA-DOC) obtained or obtainable by a process according to any one of embodiments 51 to 62.
64. Use of a NOx adsorber diesel oxidation catalyst (NA-DOC) according to any one of embodiments 1 to 50 and 63 for the NOx adsorption/desorption and the conversion of HC and CO.
65. An exhaust treatment system for the treatment of an exhaust gas, the system comprising a NOx adsorber diesel oxidation (NA-DOC) catalyst according to any one of embodiments 1 to 50 and 63;
   the system preferably further comprises one or more of a selective catalytic reduction (SCR) catalyst, a selective catalytic reduction catalyst on a filter (SCROF) and an ammonia oxidation (AMOX) catalyst.
66 The system of embodiment 65, wherein the NA-DOC catalyst is preferably located upstream of the one or more of a selective catalytic reduction (SCR) catalyst, a selective catalytic reduction catalyst on a filter (SCROF) and an ammonia oxidation (AMOX) catalyst.
67. The system of embodiment 65 or 66, comprising the NOx adsorber diesel oxidation (NA-DOC) catalyst according to any one of embodiments 1 to 50 and 63, a SCR catalyst and an AMOX catalyst,
   wherein the NA-DOC catalyst is positioned upstream of the SCR catalyst and the SCR catalyst is positioned upstream of the AMOX catalyst.
68. The system of embodiment 67, further comprising a SCROF catalyst,
   wherein the SCROF catalyst is positioned upstream of the SCR catalyst and downstream of the NA-DOC catalyst; or
   wherein the SCROF catalyst is positioned downstream of the SCR catalyst and upstream of the AMOX catalyst.
69. The system of embodiment 68, further comprising another SCR catalyst which is positioned upstream of the AMOX catalyst.
70. The system of embodiment 65 or 66, comprising the NOx adsorber diesel oxidation (NA-DOC) catalyst according to any one of embodiments 1 to 50 and 63, a SCROF catalyst and an AMOX catalyst, wherein the NA-DOC catalyst is positioned upstream of the SCR catalyst and the SCROF catalyst is positioned upstream of the AMOX catalyst.
71. A method for the treatment of an exhaust gas comprising providing an exhaust gas, preferably from an internal combustion engine, more preferably from a diesel engine;
   contacting the exhaust gas with a NOx adsorber diesel oxidation catalyst according to any one of embodiments 1 to 50 and 63.

In the context of the present invention, the term “loading of a given component/coating” (in g/in³ or g/ft³) refers to the mass of said component/coating per volume of the substrate, wherein the volume of the substrate is the volume which is defined by the cross-section of the substrate times the axial length of the substrate over which said component/coating is present. For example, if reference is made to the loading of a coating extending over x % of the axial length of the substrate and having a loading of X g/in³, said loading would refer to X gram of the coating per x % of the volume (in in³) of the entire substrate.

Further, in the context of the present invention, the term “the surface of the internal walls” is to be understood as the “naked” or “bare” or “blank” surface of the walls, i.e. the surface of the walls in an untreated state which consists—apart from any unavoidable impurities with which the surface may be contaminated—of the material of the walls.

Furthermore, in the context of the present invention, a term “X is one or more of A, B and C”, wherein X is a given feature and each of A, B and C stands for specific realization of said feature, is to be understood as disclosing that X is either A, or B, or C, or A and B, or A and C, or B and C, or A and B and C. In this regard, it is noted that the skilled person is capable of transfer to above abstract term to a concrete example, e.g. where X is a chemical element and A, B and C are concrete elements such as Li, Na, and K, or X is a temperature and A, B and C are concrete temperatures such as 10° C., 20° C., and 30° C. In this regard, it is further noted that the skilled person is capable of extending the above term to less specific realizations of said feature, e.g. “X is one or more of A and B” disclosing that X is either A, or B, or A and B, or to more specific realizations of said feature, e.g. “X is one or more of A, B, C and D”, disclosing that X is either A, or B, or C, or D, or A and B, or A and C, or A and D, or B and C, or B and D, or C and D, or A and B and C, or A and B and D, or B and C and D, or A and B and C and D.

The present invention is further illustrated by the following Examples.

### EXAMPLES

### Reference Example 1

### 1.1 Measurement of the BET Specific Surface Area

The BET specific surface area was determined according to DIN 66131 or DIN ISO 9277 using liquid nitrogen.

### 1.2 Determination of the Crystallinity

The determination of the relative crystallinity of a zeolite was performed via x-ray diffraction using a test method under the jurisdiction of ASTM Committee D32 on catalysts, in particular of Subcommittee D32.05 on zeolites. The current edition was approved on Mar. 10, 2001 and published in May 2001, which was originally published as D 5758-95.

### 1.3 Determination of the Total Pore Volume

The total pore volume was determined according to ISO 15901-2:2006.

### Catalyst Preparation

A total of 4 catalysts were prepared as listed in Table 1. Example 2.2 describes the preparation of a NOx-adsorber DOC catalyst according to the present invention. The performance benefits of the inventive Example was demonstrated over Comparative Example 2.1. To demonstrate the impact of the additional feature 2 weight-% barium on ceria of Comparative Example 2.1, two additional Comparative Examples 1.1 and 1.2 were prepared.

TABLE 1
List of the prepared catalysts

| | | | Barium in | |
|---|---|---|---|---|
| Exam- | Length of the | Length of the | bottom | Pd on |
| ples | bottom coating | top coating | coating | ceria |
| 1.1 | 70% | 100% | — | — |
| | | (50% inlet coating + | | |
| | | 50% outlet coating) | | |
| 1.2 | 70% | 100% | 2 weight-% | — |
| | | (50% inlet coating + | on ceria | |
| | | 50% outlet coating) | | |
| 2.1 | 100% | 100% | 2 weight-% | — |
| | | (50% inlet coating + | on ceria | |
| | | 50% outlet coating) | | |
| 2.2 | 100% | 100% | — | yes |
| (inven- | (50% inlet coating + | | | |
| tive) | 50% outlet coating) | | | |

### Comparative Example 1.1: Preparation of a NOx Adsorber DOC (NA-DOC)

### Bottom Coating:

A support material (a mixed oxide of Ce and Al with a ceria to alumina weight ratio of 50:50, having a BET specific surface area of 140 m²/g and a pore volume of 0.7 ml/g), was impregnated with platinum (using an aqueous solution containing an amine stabilized hydroxo Pt(IV) complex, said solution having a Pt content between 15 weight-%) and palladium (using an aqueous solution containing Pd nitrate and having a concentration in the range of 15 to 23 weight-%) in a weight ratio of 9:1, calculated as elements, respectively, via a wet impregnation process.

A slurry containing the resulting impregnated support material, ceria, a zeolitic material having a framework type BEA in its H-form (having a silica-to-alumina molar ratio, SiO₂:Al₂O₃, of 12.5:1 and a crystallinity determined by XRD>80%), zirconium acetate, such that the amount of zirconia in the bottom coating, calculated as ZrO₂, was 0.05 g/in³, and magnesium acetate, such that the amount of magnesium oxide in the bottom coating, calculated as MgO, was 0.05 g/in³, was prepared. An uncoated round flow-through honeycomb substrate, cordierite (total volume 1.9 L, 400 cpsi and 4 mil wall thickness, diameter: 143.8 mm×length: 114.3 mm), and was coated with the obtained slurry from the inlet end of the substrate toward the outlet end over 70% of the axial length of said substrate. Then, the coated substrate was dried in air at 110° C. for 1 h and calcined in air at 590° C. for 2 h. The first coating (bottom coating) contained 76.9 g/ft³ of platinum and 8.8 g/ft³ of palladium, 0.8 g/in³ of Ce/Al mixed oxide, 3.9 g/in³ of ceria, 0.35 g/in³ of H-BEA, 0.05 g/in³ of ZrO₂ and 0.05 g/in³ of MgO. The loading of the first coating was 5.20 g/in³.

### Inlet Top Coating:

A support material (alumina doped with 5 weight-% SiO₂ having a BET specific surface area of 170 m²/g and a pore volume of 0.7 ml/g), was impregnated with platinum (using an aqueous solution of stabilized Platinum complexes) and palladium (using an aqueous solution containing Pd nitrate and having a concentration in the range of 19 weight-%) at a weight ratio of 1:1, calculated as elements, respectively, via a wet impregnation process subsequent chemically fixation using barium hydroxide. Then, a slurry containing the resulting impregnated support material and a zeolitic material having a framework type BEA in its H-form (having a silica-to-alumina molar ratio, SiO₂:Al₂O₃, of 12.5:1 and a crystallinity determined by XRD>80%) was prepared.

The substrate coated with the bottom coating was then coated with the obtained slurry from the inlet end toward the outlet end of the substrate over 50% of the axial length of said substrate, forming the inlet top coat. Then, the coated substrate was dried in air at 110° C. for 1 h and calcined in air at 590° C. for 2 h. The inlet top coat comprises 14.0 g/ft³ of platinum, 14.0 g/ft³ of palladium, 0.7 g/in³ of Si-Alumina, 0.25 g/in³ of H-BEA and 0.02 g/in³ of BaO. The loading of the inlet coat was 0.97 g/in³

### Outlet Top Coating:

A support material (alumina doped with 5 weight-% MnO₂ having a BET specific surface area of 120 m²/g and a pore volume of 0.7 ml/g), was impregnated with platinum (using an aqueous solution of stabilized Platinum complexes) and palladium (using an aqueous solution containing Pd nitrate and having a concentration in the range of 19 weight-%) in a weight ratio of 9:1, calculated as elements, respectively, via a wet impregnation process subsequent chemically fixation using barium hydroxide.

The substrate with the bottom coating and the inlet coat thereon was further coated with a slurry containing the resulting impregnated support material from the outlet end toward the inlet end of the substrate over 50% of the axial length of said substrate. Then, the coated substrate was dried in air at 110° C. for 1 h and calcined in air at 590° C. for 2 h. The outlet top coat contained 82.8 g/ft³ of platinum and 9.2 g/ft³ of palladium. The loading of the outlet top coat was 1.36 g/in³. The loading of the second coating (inlet coat+outlet coat) was about 1.16 g/in³.

### Comparative Example 1.2: Preparation of a Ba/Ce-Containing NOx Adsorber DOC (NA-DOC)

### Bottom Coating:

A support material (a mixed oxide of Ce and Al with a ceria to alumina weight ratio of 50:50, having a BET specific surface area of 140 m²/g and a pore volume of 0.7 ml/g), was impregnated with platinum (using an aqueous solution containing an amine stabilized hydroxo Pt(IV) complex, said solution having a Pt content between 15 weight-%) and palladium (using an aqueous solution containing Pd nitrate and having a concentration in the range of 15 to 23 weight-%) in a weight ratio of 9:1, calculated as elements, respectively, via a wet impregnation process. Then, an oxidic material, being ceria (having a BET specific surface area of 120 m²/g), was impregnated with barium acetate, such that the amount of barium, calculated as BaO, was 2 weight-% based on the weight of the oxidic material (ceria), via a wet impregnation process and subsequently calcined at 590° C. for 2 h. A slurry was formed with the obtained Pt/Pd impregnated support material, the Ba impregnated oxidic material and a zeolitic material having a framework type BEA (having a silica-to-alumina molar ratio, SiO₂:Al₂O₃, of 12.5:1 and a crystallinity determined by XRD>80%), zirconium acetate, such that the amount of zirconia in the bottom coating, calculated as ZrO₂, was 0.05 g/in³, and magnesium acetate, such that the amount of magnesium oxide in the bottom coating, calculated as MgO, was 0.05 g/in³, was prepared. An uncoated round flow-through honeycomb substrate, cordierite (total volume 1.9 L, 400 cpsi and 4 mil wall thickness, diameter: 143.8 mm×length: 114.3 mm), and was coated with the obtained slurry from the inlet end of the substrate toward the outlet end over 70% of the axial length of said substrate. Then, the coated substrate was dried in air at 110° C. for 1 h and calcined in air at 590° C. for 2 h. The first coating (bottom coating) contained 76.9 g/ft³ platinum and 8.8 g/ft³ palladium, 0.8 g/in³ of Ce/Al mixed oxide, 3.9 g/in³ of Ba/ceria, 0.35 of H-BEA, 0.05 g/in³ of ZrO₂ and 0.05 g/in³ of MgO. The loading of the first coating was 5.20 g/in³.

### Top Coatings:

The inlet top coating and the outlet top coating of said example were prepared as the inlet coating and the outlet coating of Comparative Example 1.1 and disposed in the same manner on the substrate coated with the bottom coating.

### Comparative Example 2.1: Preparation of a Ba/Ce-Containing NOx Adsorber DOC (NA-DOC)

### Bottom Coating:

A support material (a mixed oxide of Ce and Al with a ceria to alumina weight ratio of 50:50, having a BET specific surface area of 140 m²/g and a pore volume of 0.7 ml/g), was impregnated with platinum (using an aqueous solution containing an amine stabilized hydroxo Pt(IV) complex, said solution having a Pt content between 15 weight-%) and palladium (using an aqueous solution containing Pd nitrate and having a concentration in the range of 15 to 23 weight-%) in a weight ratio of 9:1, calculated as elements, respectively, via a wet impregnation process.

Then, an oxidic material, being ceria (having a BET specific surface area of higher than 120 m²/g), was impregnated with barium acetate, such that the amount of barium, calculated as BaO, was 2 weight-% based on the weight of the oxidic material (ceria), via a wet impregnation process and subsequently calcined at 590° C. for 2 h. A slurry was formed with the obtained Pt/Pd impregnated support material, the Ba impregnated oxidic material and a zeolitic material having a framework type BEA in its H-form (having a silica-to-alumina molar ratio, SiO₂:Al₂O₃, of 12.5:1 and a crystallinity determined by XRD>80%), zirconium acetate, such that the amount of zirconia in the bottom coating, calculated as ZrO₂, was 0.05 g/in³, and magnesium acetate, such that the amount of magnesium oxide in the bottom coating, calculated as MgO, was 0.05 g/in³, was prepared. An uncoated round flow-through honeycomb substrate, cordierite (total volume 1.9 L, 400 cpsi and 4 mil wall thickness, diameter: 143.8 mm×length: 114.3 mm), and was coated with the obtained slurry from the inlet end of the substrate toward the outlet end over 100% of the axial length of said substrate. Then, the coated substrate was dried in air at 110° C. for 1 h and calcined in air at 590° C. for 2 h. The first coating (bottom coating) contained 53.8 g/ft³ of platinum, 6.2 g/ft³ of palladium, 0.8 g/in³ of Ce/Al mixed oxide, 3.9 g/in³ of Ba/ceria, 0.5 of H-BEA, 0.05 g/in³ of ZrO₂ and 0.05 g/in³ of MgO. The loading of the first coating was 5.35 g/in³.

### Inlet Top Coating:

A support material (alumina doped with 5 weight-% SiO₂ having a BET specific surface area of higher than 170 m²/g and a pore volume of higher than 0.7 ml/g), was impregnated with platinum (using an aqueous solution of stabilized platinum complexes) and palladium (using an aqueous solution containing Pd nitrate and having a concentration in the range of 15 to 23 weight-%) at a weight ratio of 1:1, calculated as elements, respectively, via a wet impregnation process subsequent chemically fixation using barium hydroxide. Then, a slurry containing the resulting impregnated support material was prepared. The substrate coated with the bottom coating was then coated with the obtained slurry from the inlet end toward the outlet end of the substrate over 50% of the axial length of said substrate, forming the inlet top coat. Then, the coated substrate was dried in air at 110° C. for 1 h and calcined in air at 590° C. for 2 h. The inlet top coat comprises 30.0 g/ft³ of platinum, 30.0 g/ft³ of palladium, 0.7 g/in³ of Si-Alumina and 0.02 g/in³ of BaO. The loading of the inlet coat was 0.73 g/in³

### Outlet Top Coating:

A support material (alumina doped with 5 weight-% SiO₂ having a BET specific surface area of higher than 170 m²/g and a pore volume of higher than 0.7 ml/g), was impregnated with platinum (using an aqueous solution of stabilized Platinum complexes) and palladium (using an aqueous solution containing Pd nitrate and having a concentration in the range of 19 weight-%) in a weight ratio of 9:1, calculated as elements, respectively, via a wet impregnation process subsequent chemically fixation using barium hydroxide. The substrate with the bottom coating and the inlet coat thereon was further coated with a slurry containing the resulting impregnated support material from the outlet end toward the inlet end of the substrate over 50% of the axial length of said substrate. Then, the coated substrate was dried in air at 110° C. for 1 h and calcined in air at 590° C. for 2 h. The outlet top coat contained 54.0 g/ft³ of platinum, 6.0 g/ft³ of palladium, 1.3 g/in³ of Si/Alumina and 0.01 g/in³ of BaO. The loading of the outlet top coating was 1.36 g/in³.

### Example 2.2: Preparation of a Pd/Ce-Containing NOx Adsorber DOC (NA-DOC)

### NA Coating (Inlet Bottom Coating):

A support material (a Ce/Al mixed oxide with a ceria to alumina weight ratio of 30:70, having a BET specific surface area of 170 m²/g and a pore volume of 0.8 ml/g), was impregnated with platinum (using an aqueous solution containing an ammine stabilized hydroxo Pt(IV) complex, said solution having a Pt content between 15 weight-%) and palladium (using an aqueous solution containing Pd nitrate and having a concentration in the range of 15 to 23 weight-%) in a weight ratio of 9:1, calculated as elements, respectively, via a wet impregnation process.

Then, an oxidic material, being ceria (having a BET specific surface area of 120 m²/g), was impregnated with barium acetate, such that the amount of barium, calculated as BaO, was 2 weight-% based on the weight of the oxidic material (ceria), via a wet impregnation process and subsequently calcined at 590° C. for 2 h. A slurry was formed with the obtained Pt/Pd impregnated support material, an oxidic material, being ceria (having a BET specific surface area of 120 m²/g), zirconium acetate, such that the amount of zirconia in the bottom coating, calculated as ZrO₂, was 0.05 g/in³, and magnesium acetate, such that the amount of magnesium oxide in the bottom coating, calculated as MgO, was 0.05 g/in³.

An uncoated round flow-through honeycomb substrate, cordierite (total volume 1.9 L, 400 cpsi and 4 mil wall thickness, diameter: 143.8 mm×length: 114.3 mm), and was coated with the obtained slurry from the inlet end of the substrate toward the outlet end over 50% of the axial length of said substrate, to form the inlet bottom coating. Then, the coated substrate was dried in air at 110° C. for 1 h and calcined in air at 590° C. for 2 h. The inlet bottom coating contained 53.8 g/ft³ of platinum, 6.2 g/ft³ of palladium, 0.8 g/in³ of Ce/Al mixed oxide, 3.9 g/in³ of ceria, 0.05 g/in³ of ZrO₂ and 0.05 g/in³ of MgO. The loading of the inlet bottom coating was 4.85 g/in³.

### NA Coating (Outlet Bottom Coating):

An oxidic material, being ceria having a BET specific surface area of 120 m²/g, was impregnated with palladium (using an aqueous solution containing Pd nitrate and having a concentration in the range of 15 to 23 weight-%). A slurry containing the resulting impregnated oxidic material was prepared and the substrate coated with the inlet bottom coat was then coated from the outlet end toward the inlet end of the substrate over 50% of the axial length of said substrate. Then, the coated substrate was dried in air at 110° C. for 1 h and calcined in air at 590° C. for 2 h. The outlet bottom coating contained 3.90 g/in³ of Pd/ceria including 60.0 g/ft³ of palladium. The loading of the outlet coating was 3.93 g/in³.

### DOC Coating (Top Coating):

A support material (alumina doped with 5 weight-% SiO₂ having a BET specific surface area of higher than 170 m²/g and a pore volume of higher than 0.7 ml/g), was impregnated with platinum (using an aqueous solution of stabilized platinum complexes) and palladium (using an aqueous solution containing Pd nitrate and having a concentration in the range of 15 to 23 weight-%) at a weight ratio of 9:1, calculated as elements, respectively, via a wet impregnation process subsequent chemically fixation using barium hydroxide.

A slurry containing the resulting impregnated support material and a zeolitic material having a framework type BEA (having a silica-to-alumina molar ratio, SiO₂:Al₂O₃, of 26:1 and a crystallinity determined by XRD>90% and containing 1.4 weight-% Fe, determined by XRD and calculated as Fe₂O₃) was prepared and coated on the cordierite flow-through substrate, with the inlet and outlet bottom coats, from the inlet end toward the outlet end over 100% of the axial length of said substrate Then, the coated substrate was dried in air at 110° C. for 1 h and calcined in air at 590° C. for 2 h. The second coating (top coating) contained 54.0 g/ft³ of platinum, 6.0 g/ft³ of palladium, 1.2 g/in³ of Si/alumina, 0.35 g/in³ of Fe-BEA and 0.1 g/in³ of BaO. The loading of the second coating was about 1.70 g/in³.

### Example 3: WLTC Evaluation of NA-DOC of Comparative Examples 1.1, 1.2 and 2.1 and Example 2.2 on a Diesel Engine

The catalysts of Comparative Examples 1.1, 1.2 and 2.1 and Example 2.2 were tested in a Worldwide Harmonized Light Vehicle Test Cycle (WLTC) on a 2 L diesel engine after hydrothermal aging at 800° C. for 16 hours in 10% steam (water)/air and subsequent sulfation and lean desulfation procedure (50 cycles). The preconditioning to the test reported was a temperature treatment of 650° C. for 10 min to purge any pre-adsorbed NOx and a shortened WLTC with a maximum temperature of 280° C. for controlled prefilling of NOx.

FIG. 1 provides the cumulated NOx storage on the NOx adsorber DOC in the cold start region of the WLTC. All formulations adsorb NOx from the exhaust leaving the engine. A net desorption of NOx adsorbed during preconditioning was not observed for any of the samples. The comparison of Comparative Examples 1.1 and 1.2 shows the benefit in NOx storage efficiency of adding barium to the formulation. Despite the fact, that in contrast to Comparative Example 2.1, the catalyst of Example 2.2 does not contain barium on ceria as NOx storage material, a significant increase in NOx storage efficiency is observed. Without wanting to be bound by any theory, it is believed that his can be attributed to the Pd/Ce feature in the outlet bottom coat of Example 2.2. Also, the stability against sulfation and lean desulfation was demonstrated with this procedure.

### Example 4 Preparation of a Pd/Ce-Containing NOx Adsorber DOC (NA-DOC)

Inlet bottom coating: the inlet bottom coating of Example 4 was prepared as the inlet bottom coating of Example 2.2 except that the platinum group metal loading was increased and that barium hydroxide was used to impregnate the 3.9 g/in³ of ceria. Thus, the loading of the inlet bottom coating was it contained 63 g/ft³ of platinum, 7 g/ft³ of palladium, 0.8 g/in³ of Ce/Al mixed oxide, 0.08 g/in³ of BaO, 3.0 g/in³ of ceria, 0.05 g/in³ of MgO and 0.05 g/in³ of ZrO₂. 4.92 g/in³.

Outlet bottom coating: the outlet bottom coating of Example was prepared as the outlet bottom coating of Example 2.2 except that the outlet bottom coat contained 3.90 g/in³ of Pd/ceria and 50.0 g/ft³ of palladium. The loading of the outlet bottom coating was 3.93 g/in³.

### Top Coating:

The top coating of Example 4 was prepared as the top coating of Example 2.2 except that it contained 54.0 g/ft³ of platinum, 6.0 g/ft³ of palladium, 1.2 g/in³ of Si/alumina, 0.5 g/in³ of Fe-BEA and 0.1 g/in³ of BaO. The loading of the top coating was about 1.85 g/in³.

### Example 5 Testing of the Catalysts of Example 1.1 and Example 4—HC and CO Light-Off Temperatures

The HC and CO light-off temperatures of the catalysts of Comparative Example 1.1 and Example 4 were measured on a 3 L diesel engine after hydrothermal aging at 800° C. for 16 hours in 10% steam (water)/air. Light-off temperatures were determined in the state of highest deactivation (10 min lean filter regeneration mode at 650° C.). Space velocity was around 30K h⁻¹, concentrations: 830-1270 ppm of CO, 160-220 ppm of THC, and 40-80 ppm of NOx. The results are shown in FIGS. 2 and 3.

As may be taken from FIGS. 2 and 3, the catalyst of Example 4 presents a lower temperature at which 50% of CO is converted, namely a CO T₅₀ of 167° C. (deactivated), compared to the temperature measured for the comparative Example, namely CO T₅₀ of 187° C. (deactivated). This is also true for the HC conversion, namely the catalyst of the present invention presents a lower HC T₇₀ of 177° C. (temperature at which 70% of HC is converted) than the comparative catalyst (187° C.). Thus, it has been demonstrated that the inventive catalyst presents improved CO and HC oxidation performance.

### Example 6: WLTC Evaluation of NA-DOC of Comparative Example 1.1 and Example 4 on a Diesel Engine

The catalysts of Comparative Examples 1.1 and Example 4 were tested in a Worldwide Harmonized Light Vehicle Test Cycle (WLTC) on a 3 L diesel engine after hydrothermal aging at 800° C. for 16 hours in 10% steam (water)/air. The preconditioning to the test reported was a temperature treatment of 650° C. for 10 min to purge any pre-adsorbed NOx and a full WLTC with a maximum temperature of 350° (FIG. 4) and shortened WLTC with a maximum temperature of 320° C. (FIG. 5) for controlled prefilling of NOx

FIGS. 4 and 5 provide the cumulated NOx storage on the NOx adsorber DOC in the cold start region of the WLTC. All formulations adsorb NOx from the exhaust leaving the engine. A net desorption of NOx adsorbed during preconditioning was not observed for any of the samples. The comparison of Comparative Examples 1.1 Example 4 shows the benefit in NOx storage efficiency of adding barium and the Pd/Ce feature to the formulation. From the comparison of Comparative Examples 1.1, 1.2 and 2.1 and Example 2.2, the main benefit in NOx adsorption can be attributed to the Pd/Ce feature. The different conditions in NOx prefilling demonstrate the capability of the catalyst to provide NOx storage efficiency under all cold start conditions.

### BRIEF DESCRIPTION OF THE FIGURES

FIG. 1 shows the cumulated NOx storage of the catalysts of Comparative Examples 1.1, 1.2 and 2.1 and Example 2.2 in a WLTC after steam aging at 800° C. for 16 h and subsequent sulfation and lean desulfation (50 cycles).

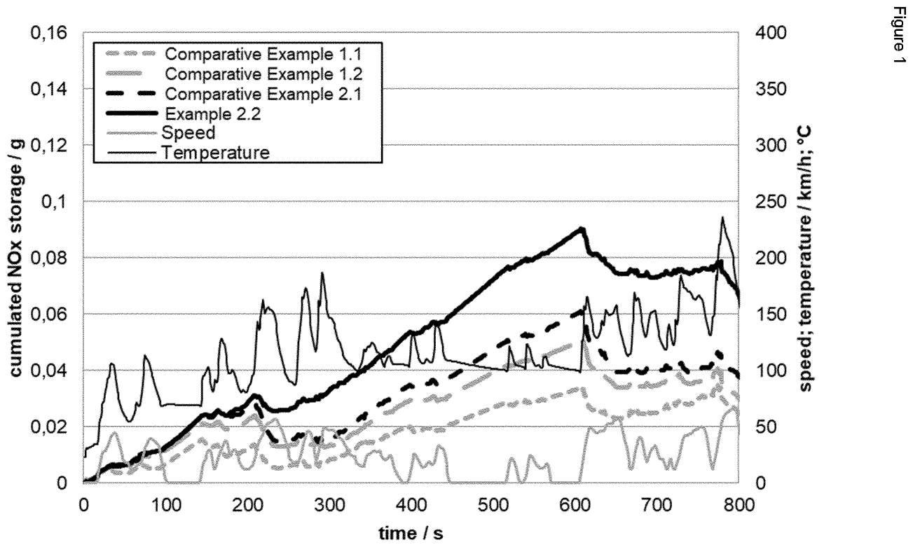

FIG. 2 shows the CO light-off temperature (CO T₅₀) of the catalysts of Comparative Example 1.1 and Example 4 after ageing (deactivated).

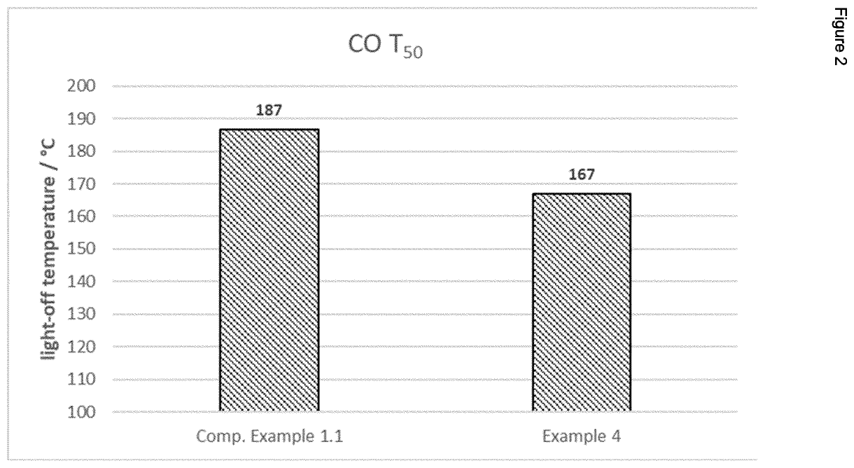

FIG. 3 shows the HC light-off temperature (HC T₇₀) of the catalysts of Comparative Example 1.1 and Example 4 after ageing (deactivated).

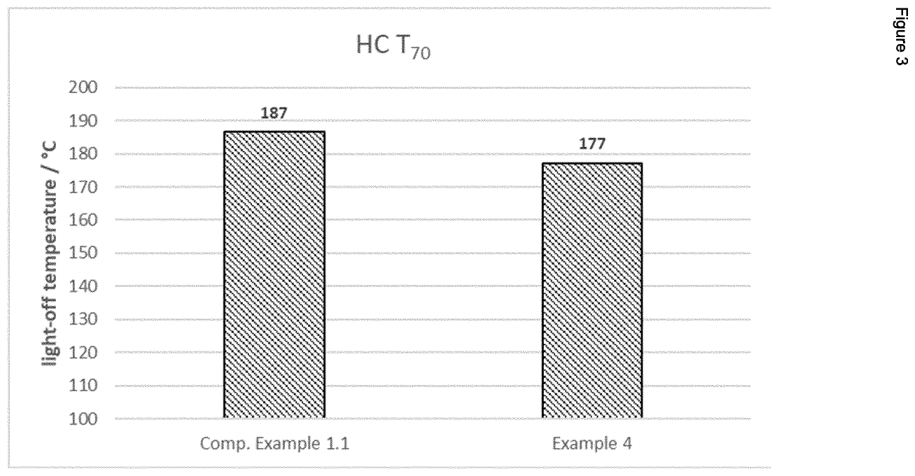

FIG. 4 shows the cumulated NOx storage of the catalysts of Comparative Example 1.1 and Example 4 in a WLTC after steam aging at 800° C. for 16 h.

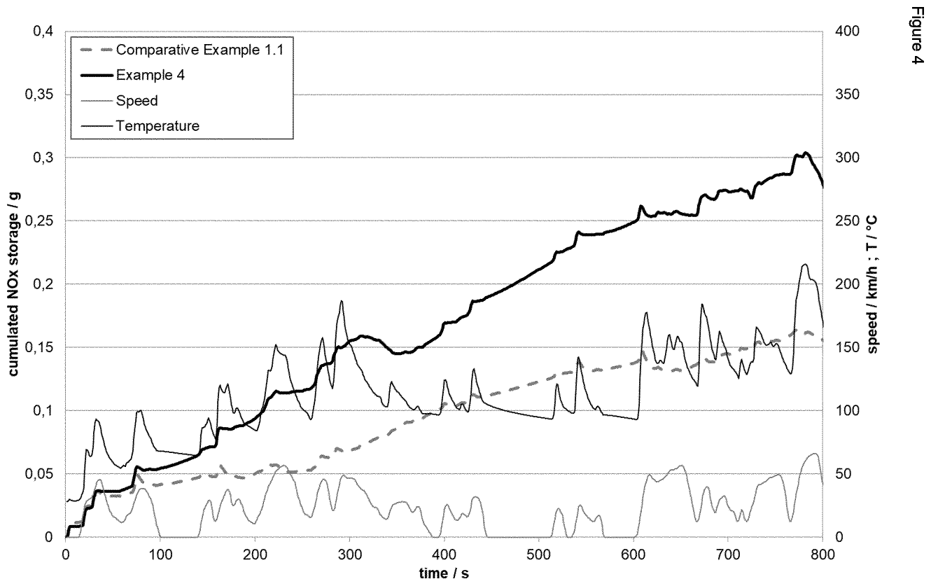

FIG. 5 shows the cumulated NOx storage of the catalysts of Comparative Example 1.1 and Example 4 in a WLTC after steam aging at 800° C. for 16 h.

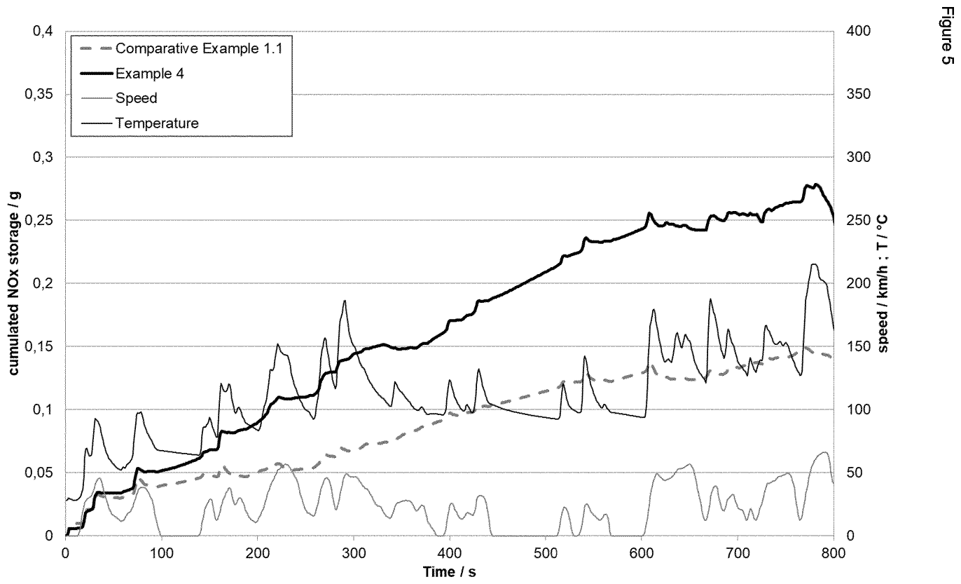

### CITED LITERATURE

WO 2016/141142 A1
WO 2020/236879 A1

1. A NOx adsorber diesel oxidation catalyst (NA-DOC) for the treatment of an exhaust gas, the catalyst comprising:
(i) a substrate comprising an inlet end, an outlet end, a substrate axial length extending from the inlet end to the outlet end and a plurality of passages defined by internal walls of the substrate extending therethrough;
(ii) a first NOx adsorber (NA) coating, said coating comprising palladium supported on a first non-zeolitic oxidic material comprising ceria;
(iii) a second NOx adsorber (NA) coating, said coating comprising one or more of an alkaline earth metal supported on a support material and a platinum group metal component supported on a second non-zeolitic oxidic material; and,
(iv) a diesel oxidation catalyst (DOC) coating, said coating comprising a platinum group metal component supported on a third non-zeolitic oxidic material;
wherein the first NA coating (ii) is disposed on the surface of the internal walls of the substrate (i) over x % of the substrate axial length from the outlet end toward the inlet end of said substrate, with x being in the range of from 20 to 70; and,
wherein the second NA coating (iii) is disposed over y % of the substrate axial length from the inlet end toward the outlet end of said substrate, with y being in the range of from 20 to 70; wherein the DOC coating is disposed on the first NA coating and the second NA coating, or on the first NA coating, the second NA coating and the surface of the internal walls of the substrate, over z % of the substrate axial length, with z being in the range of from 50 to 100.

2. The catalyst of claim 1, wherein from 95 to 100 weight-%, preferably from 98 to 100 weight-%, more preferably from 99 to 100 weight-%, more preferably from 99.5 to 100 weight-%, more preferably from 99.9 to 100 weight-%, of the first non-zeolitic oxidic material comprised in the first NA coating (ii) consist of ceria, calculated as CeO₂.

3. The catalyst of claim 1, wherein the first NA coating (ii) comprises palladium at a loading, calculated as elemental Pd, in the range of from 5 to 150 g/ft³, preferably in the range of from 10 to 120 g/ft³, more preferably in the range of from 30 to 100 g/ft³, more preferably in the range of from 40 to 80 g/ft³, more preferably in the range of from 45 to 75 g/ft³.

4. The catalyst of claim 1, wherein the second NA coating (iii) comprises the platinum group metal component, wherein the platinum group metal component is one or more of Pt, Pd, Rh, Ir, Ru and Os, preferably one or more of Pt, Pd and Rh, more preferably one or more of Pt and Pd, more preferably Pt and Pd;
wherein the weight ratio of platinum relative to palladium, calculated as Pt:Pd, is preferably in the range of from 5:1 to 15:1, more preferably in the range of from 7:1 to 12:1, more preferably in the range of from 8:1 to 10:1; and,
wherein the second NA coating (iii) preferably comprises the platinum group metal component at a loading, calculated as elemental platinum group metal, in the range of from 5 to 150 g/ft³, more preferably in the range of from 10 to 120 g/ft³, more preferably in the range of from 30 to 100 g/ft, more preferably in the range of from 40 to 80 g/ft³, more preferably in the range of from 45 to 75 g/ft³.

5. The catalyst of claim 1, wherein, in the second NA coating (iii), the second non-zeolitic oxidic material supporting the platinum group metal component is selected from the group consisting of ceria, alumina, zirconia, silica, titania, a mixed oxide comprising one or more of Ce, Al, Zr, Si, and Ti and a mixture of two or more thereof, preferably selected from the group consisting of ceria, alumina and a mixed oxide comprising one or more of Ce and Al, more preferably selected from the group consisting of ceria and a mixed oxide comprising one or more of Ce and Al, more preferably is a mixed oxide comprising Ce and Al, more preferably a mixed oxide of Ce and Al; and,
wherein the weight ratio of Ce:AI, calculated as CeO₂:Al₂O₃, more preferably is in the range of from 10:90 to 90:10, more preferably in the range of from 20:80 to 50:50, more preferably in the range of from 25:75 to 50:50.

6. The catalyst of claim 1, wherein the second NA coating (iii) further comprises an oxidic component selected from the group consisting of ceria, zirconia, alumina, silica, titania, a mixed oxide comprising one or more of Ce, Zr, Al, Si, and Ti and a mixture of two or more thereof, more preferably selected from the group consisting of ceria, zirconia, alumina and titania, more preferably selected from the group consisting of ceria, zirconia, and alumina, more preferably is ceria.

7. The catalyst of claim 1, wherein at most 0.01 weight-%, preferably at most 0.001 weight-%, more preferably at most 0.0001 weight-% of the second NA coating consist of barium, calculated as BaO.

8. The catalyst of claim 1, wherein the second NA coating (iii) comprises the alkaline earth metal supported on a support material and the platinum group metal component supported on a second non-zeolitic oxidic material;
wherein, in the second NA coating (iii), the weight ratio of the second non-zeolitic oxidic material relative to the support material is in the range of from 0.05:1 to 0.9:1, more preferably in the range of from 0.1:1 to 0.7:1, more preferably in the range of from 0.15:1 to 0.5:1, more preferably in the range of from 0.17:1 to 0.25:1;
wherein said alkaline earth metal is preferably selected from the group consisting of barium, strontium, calcium and magnesium, more preferably selected from the group consisting of barium, strontium and magnesium, more preferably is barium; and,
wherein preferably the support material supporting the alkaline earth metal in the second NA coating (iii), more preferably barium, is selected from the group consisting of ceria, zirconia, alumina, silica, titania, a mixed oxide comprising one or more of Ce, Zr, Al, Si, and Ti and a mixture of two or more thereof, more preferably selected from the group consisting of ceria, zirconia, alumina and titania, more preferably selected from the group consisting of ceria, zirconia, and alumina, more preferably is ceria.

9. The catalyst of claim 1, wherein the platinum group metal component comprised in the DOC coating (iv) is one or more of Pt, Pd, Rh, Ir, Ru and Os, preferably one or more of Pt, Pd and Rh, more preferably one or more of Pt and Pd, more preferably Pt and Pd; and,
wherein the weight ratio of platinum relative to palladium, calculated as Pt:Pd, is preferably in the range of from 2:1 to 20:1, more preferably in the range of from 5:1 to 15:1, more preferably in the range of from 7:1 to 12:1, more preferably in the range of from 8:1 to 10:1.

10. The catalyst of claim 1, wherein the third non-zeolitic oxidic material comprised in the DOC coating (iv) is selected from the group consisting of alumina, zirconia, silica, titania, a mixed oxide comprising one or more of Al, Zr, Si, and Ti and a mixture of two or more thereof, preferably selected from the group consisting of silica, alumina and a mixed oxide comprising one or more of Si and Al, more preferably selected from the group consisting of alumina and a mixed oxide comprising one or more of Si and Al, more preferably is a mixed oxide comprising Si and Al, more preferably a mixed oxide of Si and Al; and,
wherein preferably from 90 to 99 weight-%, more preferably from 92 to 98 weight-%, more preferably from 93 to 97 weight-%, of the second non-zeolitic material comprised in the DOC coating (iv) consist of alumina, and wherein preferably from 1 to 10 weight-%, more preferably from 2 to 8 weight-%, more preferably from 3 to 7 weight-%, of the DOC coating (iv) consist of silica.

11. The catalyst of claim 1, wherein the DOC coating (iv) further comprises a zeolitic material comprising one or more of iron and copper, preferably a zeolitic material comprising iron;
wherein the DOC coating (iii) comprises iron in an amount, calculated as Fe₂Os, in the range of from 0.25 to 4 weight-%, more preferably in the range of from 0.5 to 3 weight-%, more preferably in the range of from 0.75 to 2.5 weight-%, based on the weight of the zeolitic material comprising iron comprised in the DOC coating (iv); or,
wherein the DOC coating (iv) further comprises a zeolitic material it is H- and/or NH₄-form; and,
wherein the zeolitic material comprised in the DOC coating (iv) preferably is a 12-membered ring pore zeolitic material, wherein said zeolitic material more preferably has a framework type selected from the group consisting of BEA, MOR, FAU, GME, OFF a mixture of two or more thereof and a mixed type of two or more thereof, more preferably selected from the group consisting of BEA, MOR, FAU, a mixture of two or more thereof and a mixed type of two or more thereof, more preferably selected from the group consisting of BEA and FAU, wherein more preferably the 12-membered ring pore zeolitic material comprised in the DOC coating (iv) has a framework type BEA.

12. Process for preparing a NOx adsorber diesel oxidation catalyst (NA-DOC) according to claim 1, comprising
(a) preparing a first mixture comprising water, a source of palladium and a first non-zeolitic oxidic material comprising ceria;
(b) disposing the first mixture obtained according to (a) on the surface of the internal walls of a substrate comprising an inlet end, an outlet end, a substrate axial length extending from the inlet end to the outlet end and a plurality of passages defined by internal walls of the substrate extending therethrough, over x % of the substrate axial length from the outlet end toward the inlet end of said substrate, with x being in the range of from 20 to 70; calcining, obtaining a substrate having a first NOx adsorber (NA) coating thereon;
(c) preparing a second mixture comprising water and one or more of an alkaline earth metal with a support material for the alkaline earth metal and a source of a platinum group metal component with a second non-zeolitic oxidic material for supporting the platinum group metal component;
(d) disposing the second mixture obtained according to (c) on the substrate, having the first NA coating thereon, over y % of the substrate axial length from the inlet end toward the outlet end of said substrate, with y being in the range of from 20 to 70; calcining, obtaining a substrate having a first NA coating and a second NA coating thereon;
(e) preparing a third mixture comprising water, a source of a platinum group metal component and a third non-zeolitic oxidic material;
(f) disposing the third mixture obtained according to (e) on the substrate, having the first NA coating and the second NA coating thereon, over z % of the substrate axial length, with z being in the range of from 50 to 100; and,
(g) calcining the substrate obtained according to (f), obtaining a substrate having a first NA coating, a second NA coating and a DOC coating thereon.

13. A NOx adsorber diesel oxidation catalyst (NA-DOC) obtained or obtainable by a process according to claim 12.

14. Use of a NOx adsorber diesel oxidation catalyst (NA-DOC) according to claim 1 for the NOx adsorption/desorption and the conversion of HC and CO.

15. An exhaust treatment system for the treatment of an exhaust gas, the system comprising a NOx adsorber diesel oxidation (NA-DOC) catalyst according to claim 1;
the system preferably further comprises one or more of a selective catalytic reduction (SCR) catalyst, a selective catalytic reduction catalyst on a filter (SCRoF) and an ammonia oxidation (AMOX) catalyst.
